(19) United States
(12) Patent Application Publication
(10) Pub. No.: US 2009/0208003 A1
(43) Pub. Date: Aug. 20, 2009

(54) Authentication Method, Host Computer and Recording Medium

(75) Inventors: Shinichi Matsukawa, Tokyo (JP); Jun Sato, Kokubunji-shi (JP); Keiko Watanabe, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/368,889

(22) Filed: Feb. 10, 2009

(30) Foreign Application Priority Data
Feb. 15, 2008 (JP) 2008-035138

(51) Int. Cl. H04L 9/06

(52) U.S. Cl. 380/44; 380/277

(57) ABSTRACT

According to one embodiment, a host computer updates the media key block MKB in a first updatable memory device in the case where the version number of the media key block MKB read from a recording medium is newer than that of the media key block MKB in the first updatable memory device. The host computer generates a medium unique key Kmu based on a media key Km calculated from the media key block MKB read from the recording medium and a media ID read from the recording medium. The host computer executes the authentication and key exchange AKE process with the recording medium based on the medium unique key Kmu.

### CROSS-REFERENCE TO RELATED APPLICATIONS

This application is based upon and claims the benefit of priority from Japanese Patent Application No. 2008-035138, filed Feb. 15, 2008, the entire contents of which are incorporated herein by reference.

### BACKGROUND

1. Field

An embodiment of the present invention relates to an authentication method carried out by, for example, a recording medium and a host computer, the host computer and the recording medium.

2. Description of the Related Art

In the related art, it is a widespread practice to distribute content such as video, music, programs from the creator to the user through a communication network such as the Internet and ROM media. In this type of content distribution, the content may be distributed or stored in a recording medium in an encrypted form to assure confidentiality from third parties or to prohibit unauthorized copying to third parties. In such a case, a media key for decrypting the encrypted content is required with the device for browsing the encrypted content. This media key is encrypted and provided as data called the MKB (media key block) (for example, see “content Protection for Recordable Media Specification for SD Memory Card, Revision 0.961, May 3, 2007. <http://www.4centity.com/>”).

It is assumed that the recording medium has a general region or a user data area accessible from a host computer that does not require the confidential information and a protected area accessible only by a host computer that requires the confidential information.

The protected area of the recording medium is a storage region accessible by the host computer based on the confidential information. The SD cards as an example of the recording medium, has a protected area. The host computer has a device key set. The SD card and the host computer generate the same session key for each authentication process between the host computer and the recording medium (SD card). The encryption communications using this session key makes possible the read and write operation of data in the protected area from the host computer.

The host computer having no device key, on the other hand, fails in the authentication process between the host computer and the recording medium, and therefore, the data cannot be read from or written in the protected area. Also, the data cannot be correctly read from or written in the protected area without knowing the session key. Further, the host computer is required to have a tamperproof characteristic for prevention against external access to the confidential information. In the case where the confidential information leaks out of the host computer, the authentication process between the host computer and the recording medium is equipped with a mechanism to invalidate the access from the host computer having the confidential information that has leaked (see, for example, Jpn. Pat. Appln. KOKAI Publication No. 2004-220317).

The recording medium having the protected area also has a general region where the read and write operation is possible without authentication. For example, the content of a video is encrypted with an encryption key and the resulting encrypted content is recorded in the general region of the recording medium while the encryption key is stored in the protected area. By doing so, a browser for executing a specified reproduction program can read the encryption key from the protected area of the recording medium, decrypt the encrypted content in the general region using the encryption key and reproduce the video content thus obtained.

Other digital content data, such as music, images or programs may be recorded in the recording medium. In such a case, the content provided by the content provider may be illegally altered before being recorded in the recording medium. According to a method for detecting and preventing illegal alteration, if any, during the execution of the process, an electronic signature is added by executing the electronic signature process on the content, and verified in the recording medium.

This process requires information called the alteration-detecting public key. This public key, which may be placed in the public domain, is required to be held in the recording medium and not be rewritten. A public key algorithm is described, for example, in “Alfred J. Menezes, Paul C. Van Oorschot, Scott A. Vanstone, Handbook of Applied Cryptography, CRC Press, 1996”. The aforementioned authentication process between the host computer and the recording medium plays an important role in recording the content.

The content protection is adversely affected, however, in the case where the confidential information in the protected area of the recording medium is illegally made public as data accessible by the host computer. To prevent this inconvenience, a mechanism is available by which the recording medium and the host computer illegally processed are removed as an illegal device (for example, see “Advanced Access Content System, Introduction and Common Cryptographic Elements, Revision 0.91, Feb. 16, 2006 <http://www.aacsla.com/>”). According to this mechanism, the recording medium and the host computer authenticate each other.

This type of mutual authentication can be realized by (i) a method in which both the recording medium and the host computer have a common key or (ii) a method in which both the recording medium and the host computer execute the encryption and decryption process based on the public key algorithm Especially, the method (ii) poses the problem of the circuit size and the load on the arithmetic operation.

Also, the recording medium having the content alteration detection function is required to be internally equipped with the confidential information and the unrewritable information. The recording medium meeting this condition is required to have a tamperproof characteristic for prevention against external access to the information. The packaging of the tamperproof characteristic, however, requires a sophisticated technique, and therefore, a recording medium having an insufficient tamperproof characteristic may be placed on the market. Such a recording medium having an insufficient tamperproof characteristic is also required to be removed as an illegal device.

Also, the recording medium is often limited in such resources as the computation memory or the computation capability, and therefore, is required to be compatible with the existing mechanism.

To summarize, the toad of the mutual authentication process between the recording medium and the host computer is desirably reduced while at the same time maintaining the existing mechanism for preventing the connection of illegal devices between the recording medium and the host computer.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram showing the general configuration of an authentication system according to a first embodiment of the invention;

FIG. 2 is an exemplary schematic diagram showing the configuration of the MKB data according to the same embodiment;

FIG. 3 is an exemplary schematic diagram showing the configuration of the recording medium certificate data according to the same embodiment;

FIG. 4 is an exemplary sequence diagram for explaining the operation of the key generation center according to the same embodiment;

FIG. 5 is an exemplary schematic diagram for explaining the initialization and the data distribution according to the same embodiment;

FIG. 6 is an exemplary sequence diagram for explaining the operation of the host computer according to the same embodiment;

FIG. 7 is an exemplary schematic diagram for explaining the authentication process according to the same embodiment;

FIGS. 8 and 9 are exemplary sequence diagrams for explaining the operation of the host computer according to the same embodiment;

FIG. 10 is an exemplary sequence diagram for explaining the operation of the recording medium according to the same embodiment;

FIG. 11 is an exemplary schematic diagram for explaining the authentication process according to the same embodiment;

FIG. 12 is an exemplary schematic diagram showing the general configuration of the authentication system according to a second embodiment of the invention;

FIG. 13 is an exemplary schematic diagram showing the configuration of the MKB data according to the same embodiment;

FIG. 14 is an exemplary sequence diagram for explaining the operation of the key generation center according to the same embodiment;

FIG. 15 is an exemplary schematic diagram for explaining the initialization and the data distribution according to the same embodiment;

FIG. 16 is an exemplary sequence diagram for explaining the operation of the host computer according to the same embodiment;

FIG. 17 is an exemplary schematic diagram for explaining the authentication process according to the same embodiment;

FIG. 18 is an exemplary sequence diagram for explaining the operation of the host computer according to the same embodiment;

FIG. 19 is an exemplary sequence diagram for explaining the operation of the host computer and the recording medium according to the same embodiment; and

FIG. 20 is an exemplary schematic diagram for explaining the authentication process according to the same embodiment.

### DETAILED DESCRIPTION

Various embodiments according to the invention will be described hereinafter with reference to the accompanying drawings. In general, according to one embodiment of the invention, there is provided an authentication method executed by a host computer comprising at least a first updatable memory device for storing the media key block MKB generated by a key management center unit and a first non-updatable memory device for storing the device key Kd and the center public key Kk-pub generated by the key management center unit on the one hand and by a recording medium comprising a second updatable memory device for storing the media key block MKB and the media key Km generated by the key management center unit and a second non-updatable memory device for storing the center public key Kk-pub, the recording medium certificate Kc-CERT and the recording medium private key Kc-pri generated by the key management center unit on the other hand, the method comprising: the host computer executing the process of reading the media key block MKB in the second updatable storage device and the recording medium certificate KC-CERT in the second non-updatable storage device from the recording medium; an MKB verification/updating module of the host computer comparing the version number of the media key block MKB read from the recording medium with the version number of the media key block MKB in the first updatable memory device; the MKB verification/updating module verifying the key generation center signature of the media key block MKB from the recording medium based on the center public key Kk-pub in the first non-updatable memory device in the case where the comparison result shows that the version number of the media key block MKB from the recording medium is newer; the MKB verification/updating module rewriting the media key block MKB in the first updatable memory device into the media key block MKB from the recording medium in the case where the verification is successful; a certificate verification module of the host computer, after the rewrite operation, verifying the key generation center signature of the recording medium certificate Kc-CERT based on the center public key Kk-pub in the first non-updatable memory device; a recording medium verification module of the host computer reading the media ID from the recording medium certificate Kc-CERT and judging whether the media ID is contained in the recording medium invalidation list of the media key block MKB in the first updatable memory device in the case where the verification is successful; an MKB processing module of the host computer calculating the media key Km by the MKB process of the media key block MKB from the recording medium based on the device key Kd in the first non-updatable memory device in the case where the judgment shows that the media ID is not contained in the recording medium invalidation list; a first Kmu generating module of the host computer generating the media unique key Kmu based on the media ID and the media key Km in the recording medium certificate Kc-CERT; and a first AKE execution module of the host computer executing the authentication and key exchange AKE process with a second AKE execution module of the recording medium based on the media unique key Kmu.

Each of the devices described below can be implemented in either a hardware configuration or a combination of hardware resources and software. The software of the combined configuration is installed as a program in the computer of the corresponding device from a network or a recording medium to realize the functions of the corresponding device. Also, a first embodiment represents a form using a public key, and a second embodiment represents a form using no public key.

### First Embodiment

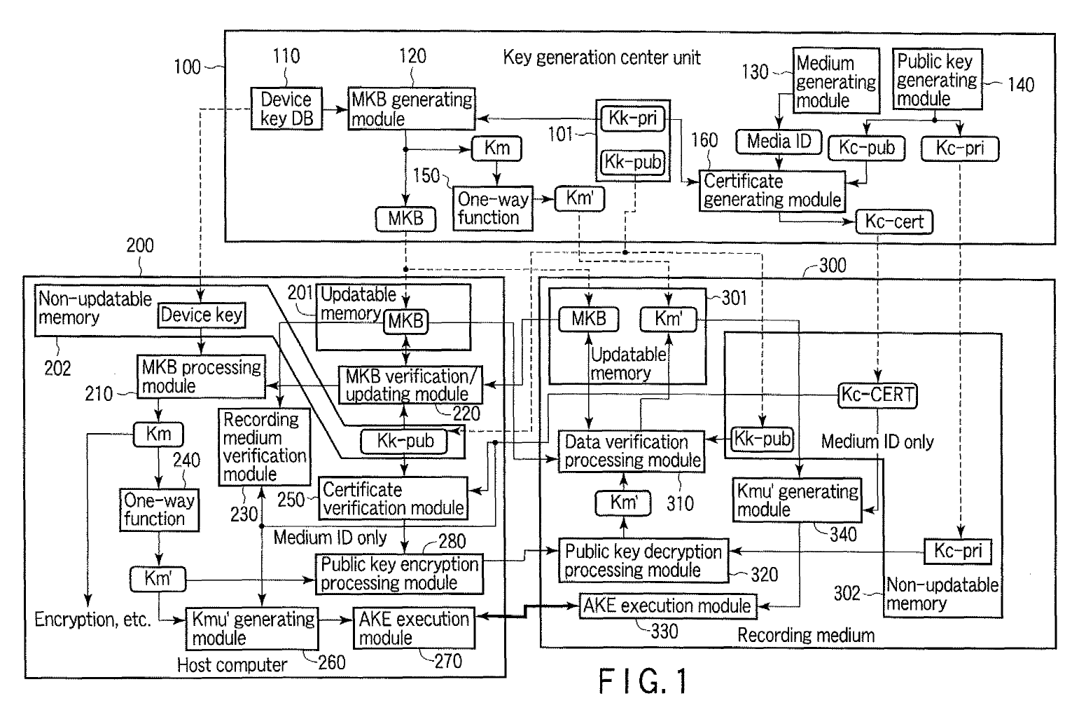

FIG. 1 is a diagram showing a general configuration of an authentication system according to the first embodiment of the invention. This authentication system includes a key generation center unit 100, a host computer 200 and a recording medium 300. Actually, the whole system is configured of one key generation center unit, plural host computers and plural recording media. The case under consideration, however, involves a system including one host computer and one recording medium as a typical example.

The key generation center unit 100 is configured of a key pair memory device 101, a device key DB 110, an MKB generating module 120, a media ID generating module 130, a public key generating module 140, a one-way function calculation module 150 and a certificate generating module 160. Incidentally, the one-way function calculation module 150 may be omitted, in which case the updatable memory 302 of the recording medium 300 stores the media key Km.

The key pair memory device 101 is a random access memory unit that can be read from or written into for holding a pair of public keys, including a center public key Kk-pub and a center private key Kk-pri generated in advance.

The device key DB (Database) 110 is a random access memory unit that can be read from or written into and holds device keys Kd_1 to Kd_x generated in advance.

The MKB generating module 120 has the function of generating the media key Km by random number generation, the function of encrypting the media key Km based on the device keys Kd_1 to Kd_x in the device key DB 110 and generating the encrypted media keys Enc (Kd_1, Km), . . . , Enc (Kd_x, Km), the function of inputting the media key Km to the one-way function calculation module 150 and receiving a media key function value Km′ from the one-way function calculation module 150, the function of encrypting predetermined unique data with the media key Km and the media key function value Km′ and generating the verified data Enc (Km, fixed data) and Enc (Km′, fixed data), respectively, the function of generating the key generation center signature by executing the electronic signature process on the version number, the verification data, the encrypted media key and the recording medium invalidation list by the center private key Kk-pri in the key pair memory device 101 using the version number and the recording medium invalidation list input from an input module (not shown), and the function of generating the media key block MKB including the version number, the verification data, the encrypted media key, the recording medium invalidation list and the key generation center signature.

The media key block MKB may also be called the key management information. The media key Km can be calculated by the MKB process using the device keys Kd_1 to Kd_x from the media key block MKB. The media key is not calculated, however, even by execution of the MKB process from the desirably invalidated device keys of the media key block MKB. The media key block MKB is used for the purpose of, for example, invalidating the host computer failing to comply with a predetermined rule (see, for example, “Content Protection for Recordable Media Specification for SD Memory Card, Revision 0.961, May 3, 2007. <http://www.4centity.com/>” and “Content Protection for Recordable Media Specification, Introduction and Common Cryptographic Elements, Revision 1.01, May 3, 2007. <http://www.4centity.com/>”). Also, in the case of a change in the mass of the invalidated host computer and recording medium such as the increase in the invalidated host computers or the recording media in the media key block MKB, the version number of the media key block MKB described later is sequentially renewed.

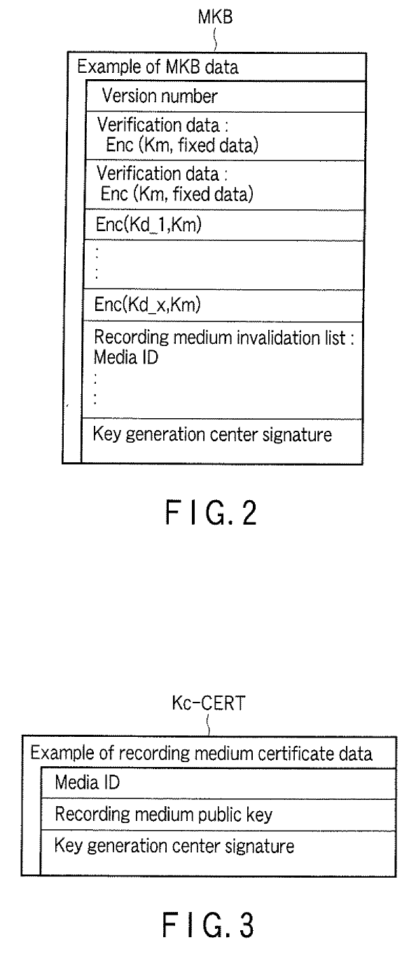

Various types of media key blocks MKB are available. The method described in, for example, “Content Protection for Recordable Media Specification for SD Memory Card, Revision 0.961, May 3, 2007. <http://www.4centity.com/>” is generally used. A simple model of the media key block MKB is shown in FIG. 2 as an example. This media key block MKB includes the version number, the verification data, the encrypted media key, the recording medium invalidation list and the key generation center signature.

The version number is the data indicating the degree of newness of the media key block MKB.

The verification data Enc (Km, fixed data) and Enc (Km′, fixed data) are the unique encrypted data obtained by encrypting the fixed data with the media key Km or the media key function value Km′, respectively. In this specification, the expression Enc (A, B) designates the encrypted data obtained by encrypting the data B with the key A. In other words, it indicates the data B in the state encrypted by the key A. The verification data is for checking whether the media key Km and the media key function value Km′ read from the media key block MKB are legitimate or not. By decrypting this verification data with the media key Km and the media key function value Km′ obtained from the MKB process, predetermined fixed data is restored. As a result, the success in the MKB process can be confirmed.

The encrypted media keys Enc (Kd_1, Km), Enc (Kd_x, Km) are each the media key Km encrypted with predetermined device keys Kd_1, . . . , Kd_x, respectively. The media key Km can be restored by decrypting the encrypted media keys Enc (Kd_1, Km), . . . , Enc (Kd_x, Km) with the device keys Kd_1, . . . , Kd_x, respectively.

The recording medium invalidation list is a list of the media IDs as information for identifying the desirably invalidated recording medium.

The key generation center signature is an electronic signature obtained by executing the electronic signature process with the center private key Kk-pri of the key generation center unit 100 on the version number, the verification data, the encrypted media key and the recording medium invalidation list described above. The electronic signature is a technique for making it difficult to illegally alter the data using the public key algorithm in terms of computational complexity, and can be realized by the method described in, for example, “Alfred J. Menezes, Paul C. Van Oorschot, Scott A. Vanstone, Handbook of Applied Cryptography, CRC Press, 1996”.

The media ID generating module 130 has the function of generating the media ID in such a manner as not to duplicate a media ID generated in the past, for example, by executing the process of issuing a serial number or collating with past media IDs after random number generation. In addition to the aforementioned process of issuing the serial number and collation after random number generation, the media ID generating module 130 can execute any arbitrary process for generating the media ID in a manner that does not duplicate a media ID generated in the past. This is also the case with the embodiments described below.

The public key generating module 140 has the function of generating a public key pair, which includes the recording medium public key Kc-pub and the recording medium private key Kc-pri, according to the public key algorithm such as RSA.

The one-way function calculation module 150 has the function of calculating the media key function value Km′ as the result of the arithmetic operation to obtain the one-way function of the media key Km received from the MKB generating module 120. The one-way function is defined as a function having such a characteristic that the estimation of the original input value based on the output from the function itself is difficult in terms of computational complexity. This function can be realized, for example, by the calculation formula described in “Content Protection for Recordable Media Specification, Introduction and Common Cryptographic Elements, Revision 1.01, May 3, 2007. <http://www.4centity.com/>”. Incidentally, the media key function value Km′ may also be called the media key hash value Km′.

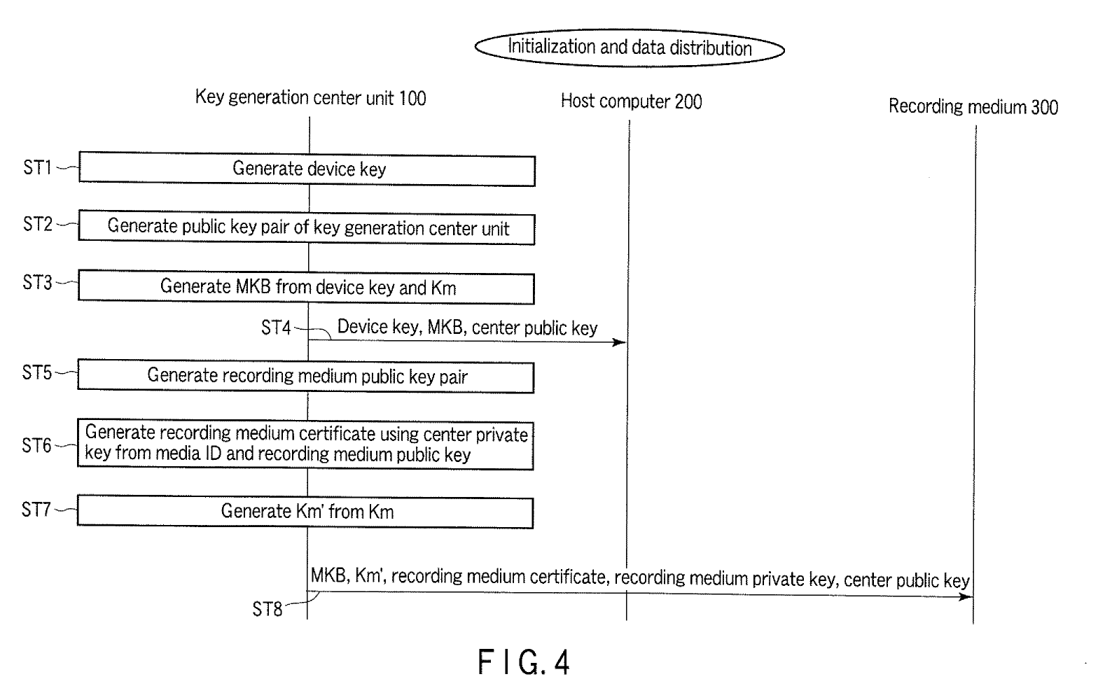

The certificate generating module 160 has the function of generating predetermined format data from the media ID and the recording medium public key Kc-pub and generating the key generation center signature by executing the electronic signature process on the format data based on the center private key Kk-pri, and the function of generating, as shown in FIG. 3, the recording medium certificate Kc-CERT including the media ID, the recording medium public key Kc-pub and the key generation center signature. The electronic signature algorithm uses the scheme described in, for example, “Alfred J. Menezes, Paul C. Van Oorschot, Scott A. Vanstone, Handbook of Applied Cryptography, CRC Press, 1996”.

The host computer 200 is configured of an updatable memory 201, a non-updatable memory 202, an MKB process module 210, an MKB verification/updating module 220, a recording medium verification module 230, a one-way function calculation module 240, a certificate verification module 250, a Kmu′ generating module 260, an AKE execution module 270 and a public key encryption process module 280. The one-way function calculation module 240 may be omitted, in which case the media key Km is used in place of the media key function value Km′ on the one hand and the media unique key Kmu=one way (Km, media ID) is used in place of the media unique key Kmu′=one way (Km′, media ID) on the other hand.

The updatable memory 201 is a memory that can be read from and written into by each of the modules 210 to 280 and holds the media key block MKB. The word “updatable” is defined as a state in which the media key block MKB can be rewritten.

The non-updatable memory 202, on the other hand, can be read by each of the modules 210 to 280 and cannot be updated, and holds one device key Kd_1 and one center public key Kk-pub. The one device key Kd_1 may be any one of the device keys Kd_1 to Kd_x. In this case, however, Kd_1 is used as an example. Also, the word “non-updatable” is defined as a state in which the device key and the center public key Kk-pub cannot be rewritten.

The MKB processing module 210 has the function of executing the MKB process on the media key block MKB from the recording medium 300 based on the device key Kd in the non-updatable memory 202 in the case where the judgment by the recording medium verification module 230 shows that the recording medium 300 is not to be invalidated, and the function of sending out the media key Km obtained by the MKB process to the one-way function calculation module 240.

The MKB verification/updating module 220 has the function of comparing the version number of the media key block MKB read from the recording medium 300 with the version number of the media key block MKB in the updatable memory 201, the function of not executing the process of updating the media key block MKB in the case where the comparison shows that the two version numbers are identical to each other or the version number of the media key block MKB in the updatable memory 201 is newer, the function of verifying the key generation center signature of the media key block MKB from the recording medium 300 based on the center public key Kk-pub in the non-updatable memory 202 in the case where the comparison shows that the version number of the media key block MKB read from the recording medium 300 is newer, and the function of rewriting the media key block MKB in the updatable memory 201 into the media key block MKB derived from the recording medium 300, if the verification is successful.

The recording medium verification module 230 has the function of reading the media ID from the recording medium certificate Kc-CERT in the case where the verification by the certificate verification module 250 described later is successful, the function of judging whether the media ID thus read is contained in the recording medium invalidation list in the media key block MKB in the updatable memory 201 or not, and the function of suspending the process by determining that the recording medium 300 is to be invalidated in the case where the judgment shows that the media ID in the recording medium certificate Kc_CERT is contained in the recording medium invalidation list.

The one-way function calculation module 240 has the function of generating the media key function value Km′ by calculating the one-way function of the media key Km sent out from the MKB processing module 210, and the function of sending out the media key function value Km′ to the Kmu′ generating module 260.

The certificate verification module 250 has the function of verifying the key generation center signature of the recording medium certificate Kc-CERT based on the center public key Kk-pub in the non-updatable memory 202 in the case where the comparison by the MKB verification/updating module 220 shows that the two version numbers are identical, and the function of suspending the process in the case of a verification failure.

The Kmu′ generating module 260 has the function of generating the media unique key Kmu′=one way (Km′, media ID) by calculating the one-way function “one way( )” based on the media ID in the recording medium certificate Kc-CERT read from the recording medium 300 and the media key function value Km′ received from the one-way function calculation module 240, and the function of sending out the media unique key Kmu′ to the AKE execution module 270 or the public key encryption process module 280.

The AKE execution module 270 has the function of executing the AKE process with the recording medium 300 based on the media unique key Kmu′ received from the Kmu′ generating module 260.

The public key encryption process module 280 has the function of generating the encrypted media key function value Enc (Kc-pub, Km′) by encrypting the media key function value Km′ received from the one-way function calculation module 240, using the recording medium public key Kc-pub in the recording medium certificate Kc-CERT.

The recording medium 300 includes an updatable memory 301, a non-updatable memory 302, a data verification process module 310, a public key decryption process module 320, an AKE execution module 330 and a Kmu′ generating module 340.

The updatable module 301, which is updatable and can be read from and written into by each of the modules 310 to 340, holds the media key block MKB and the media key function value Km′. Incidentally, the media key Km may be held in place of the media key function value Km′. The word “updatable” is defined as a state in which the media key block MKB and the media key function value Km′ can be rewritten.

The non-updatable memory 302, which can be read by the modules 310 to 340 and cannot be updated, holds the recording medium certificate Kc-CERT, the recording medium private key KC-pri and the center public key Kk-CERT. The word “non-updatable” is defined as a state in which the recording medium certificate Kc-CERT, the recording medium private key KC-pri and the center public key Kk-pub cannot be rewritten.

The data verification processing module 310 has the function of comparing the version number of the media key block MKB from the host computer 200 with the version number of the media key block MKB in the updatable memory 301, the function of verifying the key generation center signature in the media key block MKB from the host computer 200 based on the center public key Kk-pub in the non-updatable memory 302 in the case where the comparison shows that the version number of the media key block MKB of the host computer 200 is newer, the function of starting the public key decryption process module 320 in the case where the verification is successful, and the function of rewriting the media key function value Km′ (or the media key Km) and the media key block MKB in the updatable memory 301 into the media key function value Km′ (or the media key Km) and the media key block MKB received from the host computer 200, respectively, in the case where the verification by the public key decryption process module 320 is successful.

The public key decryption process module 320 has the function of decrypting the encrypted media key function value Enc (Kc-pub, Km′) from the host computer 200 with the recording media key Kc-pri in the non-updatable memory 302 in the case where the verification by the data verification process module 310 is successful, and the function of verifying the media key function value Km′ obtained by decryption, using the verification data Enc (Km′, fixed data) in the media key block MKB from the host computer 200. This verification is carried out by decrypting the verification data Enc (Km′, fixed data) in the media key block MKB based on the media key function value Km′ obtained and judging whether the fixed data can be restored correctly or not. Incidentally, in the absence of the one-way function calculation modules 150, 240, the encrypted media key Enc (Kc-pub, Km), the media key Km and the verification data Enc (Km, fixed data) are used in place of the encrypted media key function value Enc (Kc-pub, Km′), the media key function value Km′ and the verification data Enc (Km′, fixed data), respectively.

The AKE execution module 330 has the function of executing the AKE process with the host computer 200 based on the media unique key Kmu′ received from the Kmu′ generating module 340.

The Kmu′ generating module 340 has the function of generating the media unique key Kmu′ by the arithmetic operation of the media key function value Km′ in the updatable memory 301 after rewriting by the data verification process module 310 and the one-way function with the media ID in the recording medium certificate KC-CERT in the non-updatable memory 302, and the function of sending out the media unique key Kmu′ to the AKE execution module 330. Incidentally, in the absence of the one-way function calculation modules 150, 240, the media key Km and the media unique key Kmu are used in place of the media key function value Km′ and the media unique key Kmu′, respectively.

The various modules of the systems described herein can be implemented as software applications, hardware and/or software modules, or components on one or more computers, such as servers. While the various modules are illustrated separately, they may share some or all of the same underlying logic or code.

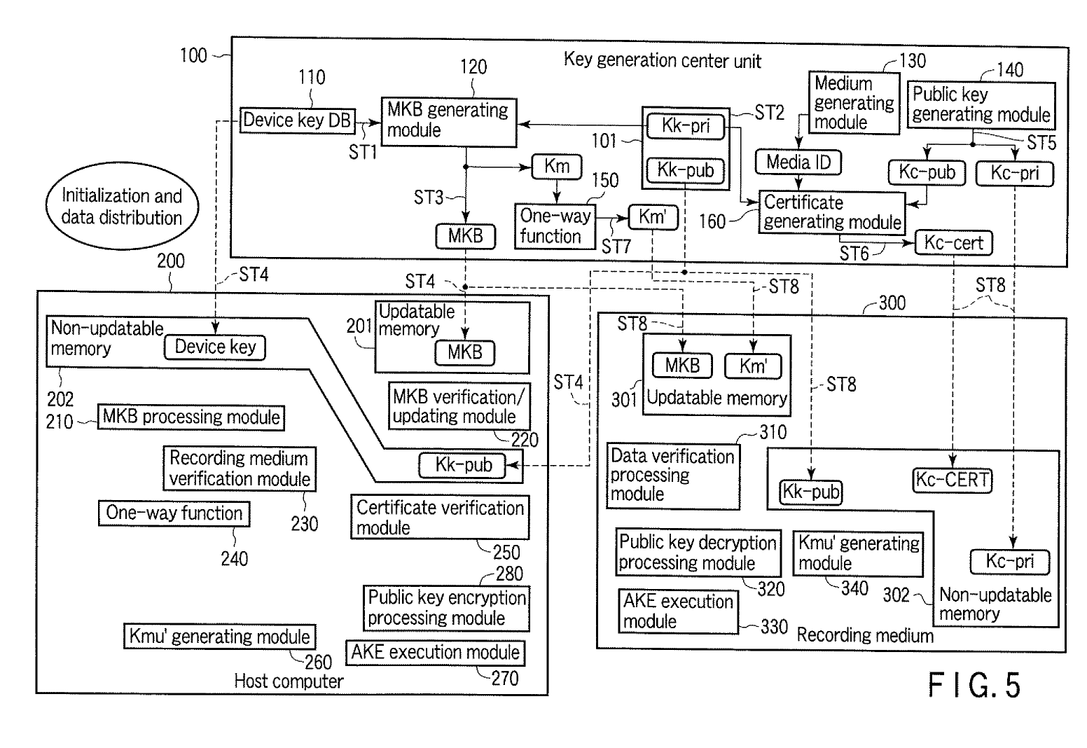

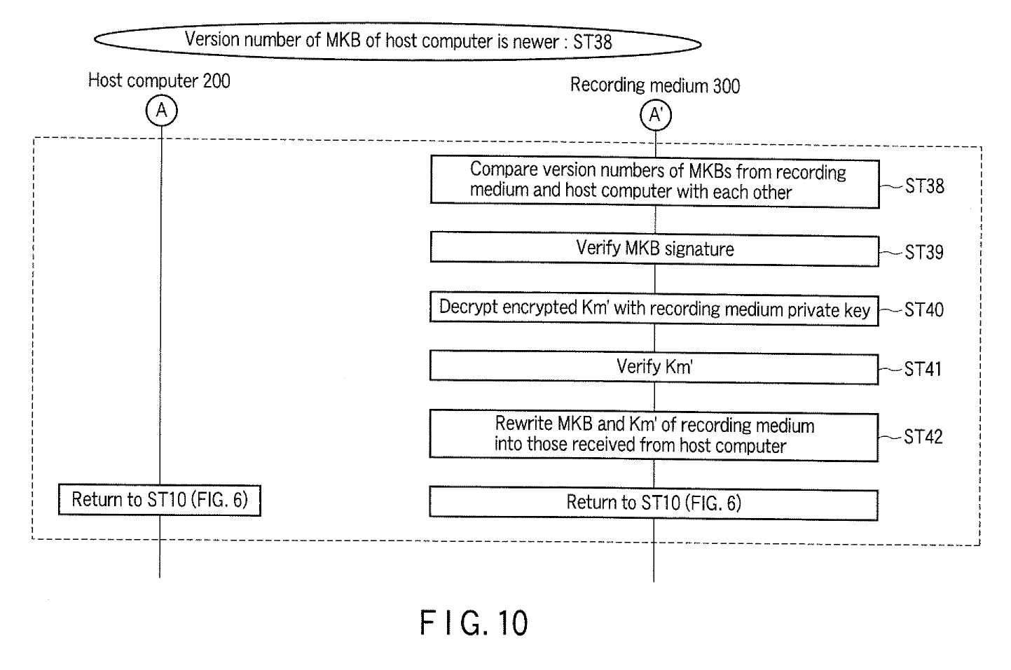

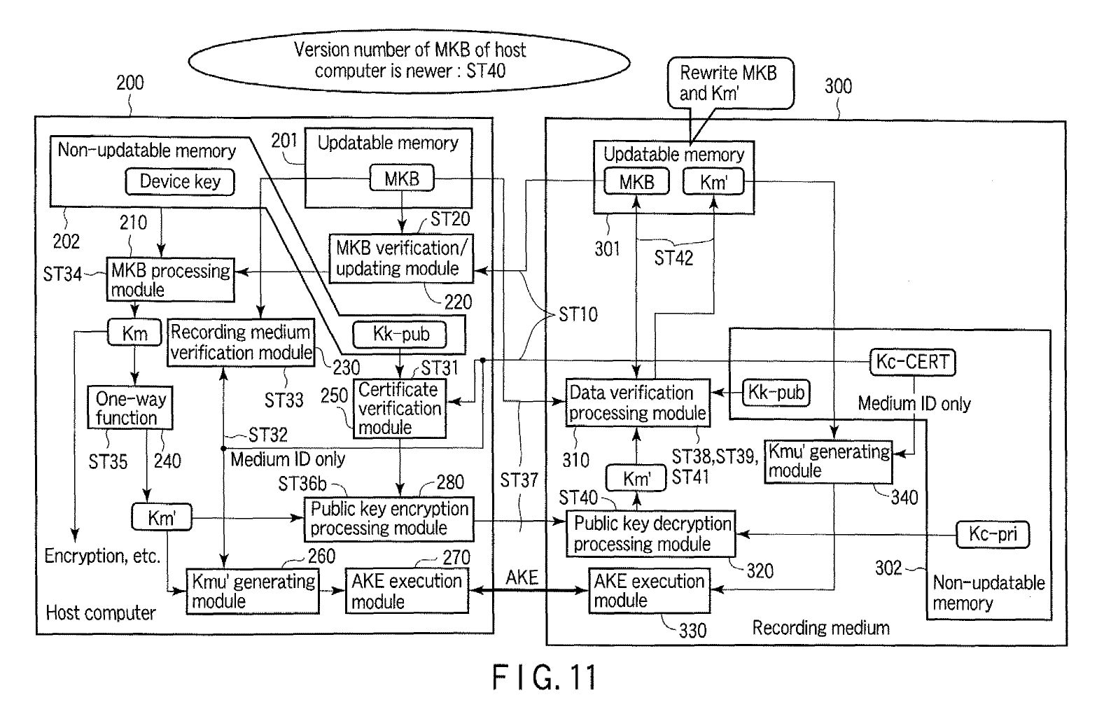

Next, the operation of the authentication system configured as described above is explained with reference to FIGS. 4 to 11. First, the key generation center unit 100 performs the initialization and distributes the data such as the key. The host computer maker and the recording medium maker record the data distributed from the key generation center unit 100, in the host computer 200 and the recording medium 300, respectively. Nevertheless, the key generation center unit 100 may alternatively be so configured as to record the key and other data in the host computer 200 and the recording medium 300. Also, the host computer 200 and the recording medium 300 are distributed to and acquired by the user to execute the authentication process between the host computer and the recording medium on the part of the user. This process is sequentially explained below.

(Initialization and Data Distribution)

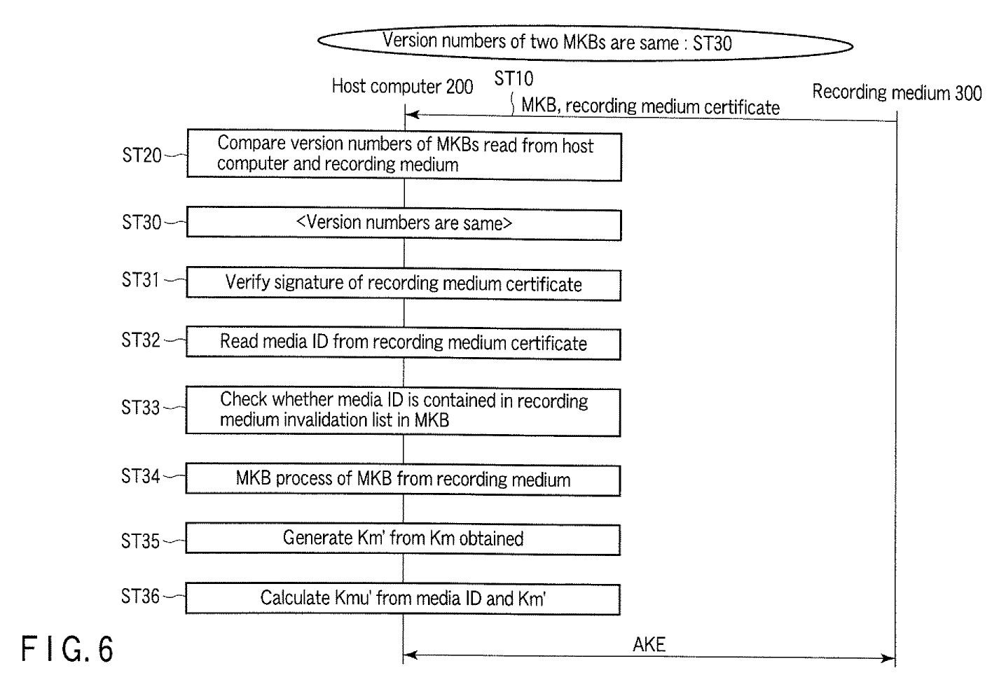

The key generation center unit 100, as shown in FIGS. 4 and 5, generates the device key Kd used and those (Kd_1 to Kd_x) to be used in the future in the authentication system (ST1), and holds the device keys Kd_1 to Kd_x in the device key DB.

Also, the key generation center unit 100 generates the public key pair of the key generation center unit 100 in advance (ST2). This public key pair is held in the key pair memory device 101.

In the key generation center unit 100, the MKB generating module 120 generates a random number as the media key Km. This random number may be alternatively supplied from an external source.

Next, the MKB generating module 120, based on the device keys Kd_1 to Kd_x in the device key DB 110, encrypts the media key Km and generates the encrypted media keys Enc (Kd_1, Km), . . . , Enc (Kd_x, Km).

Also, the MKB generating module 120 inputs the media key Km to the one-way function calculation module 150 and receives the media key function value Km′ from the one-way function calculation module 150.

Further, the MKB generating module 120 encrypts predetermined fixed data using the media key Km and the media key function value Km′ and thus generates the verification data Enc (Km, fixed data) and Enc (Km′, fixed data), respectively.

Also, the MKB generating module 120, using the recording medium invalidation list and the version number input from an input module, not shown, executes the electronic signature process on the version number, the verification data, the encrypted media key and the recording medium invalidation list using the center secret key Kk-pri in the key pair memory device 101, thereby generating the key generation center signature.

After that, the MKB generating module 120, as shown in FIG. 2, generates the media key block MKB including the version number, the verification data, the encrypted media key, the recording medium invalidation list and the key generation center signature (ST3).

One of the device keys Kd_1 to Kd_x, the center public key Kk-pub and the media key block MKB described above are written in the updatable memory 201 or the non-updatable memory 202 of the host computer 200 through the host computer maker (ST4). Incidentally, the device key may be varied with each host computer 100 (for example, serial number) or each model (for example, model number) thereof. This concept of attaching the device key is determined from the viewpoint of system operation. The media key block MKB may alternatively be written by being downloaded from the key generation center unit 100 by the user who has purchased the host computer 100 instead of by the host computer maker. In the case where the media key block MKB is written by the host computer maker, however, the latest media key block MKB is advantageously spread in the authentication system quickly.

Now, the steps of generating the data assigned to the recording medium 300 are described.

In the key generation center unit 100, the public key generating module 140 generates pairs of public keys, including the recording medium public key Kc-pub and the recording medium secret key Kc-pri according to the public key algorithm such as RSA (ST5).

In the key generation center unit 100, the media ID generating module 130 generates the media ID in such a manner as not to duplicate a past media ID by issuing the serial number, for example. Incidentally, the media ID may be assigned from an external source instead of being generated in the key generation center unit 100. Also, either one of the public key generating module 140 and the media ID generating module 130 may operate before the other.

Next, in the key generation center unit 100, the certificate generating module 160, as shown in FIG. 3, generates the electronic signature for the media ID and the recording medium public key Kc-pub based on the center secret key Kk-pri to thereby generate the recording medium certificate KC-CERT (ST6).

Also, in the key generation center unit 100, the one-way function calculation module 150 calculates the media key function value Km′ according to the one-way function from the media key Km received from the MKB generating module 120 (ST7).

The media key block MKB and the corresponding media key function value Km′, the recording medium certificate Kc-CERT, the recording medium secret key Kc-pri and the center public key Kk-pub are written in the updatable memory 301 or the non-updatable memory 302 of the recording medium 300 through the recording medium maker (ST8).

(Authentication Between Host Computer and Recording Medium)

First, the authentication operation is briefly described.

The authentication operation between the host computer 200 and the recording medium 300 is varied with the result of comparison between the version number of the media key block MKB in the host computer 200 and the version number of the media key block MKB in the recording medium 300. The result of comparison of the version numbers is one of the following three cases:

(1) The version numbers of the media key blocks MKB of the host computer 200 and the recording medium 300 are identical to each other.

(2) The version number of the media key block MKB of the recording medium 300 is newer than that of the host computer 200.

(3) The version number of the media key block MKB of the host computer 200 is newer than that of the recording medium 300.

In the cases of (2) or (3), the older media key block MKB is updated. After completion of the process of updating the media key block MKB, the host computer 200 and the recording medium 300 execute the authentication and key exchange process AKE. The authentication and key exchange process AKE is described, for example, in “Alfred J. Menezes, Paul C. Van Oorschot, Scott A. Vanstone, Handbook of Applied Cryptography, CRC Press, 1996”. This authentication and key exchange process AKE is not described in detail here. The host computer 200 and the recording medium 300 compute the common media unique key Kmu′ used for the authentication and key exchange process AKE, according to the one-way function from the media key function value Km′ (or the media key Km) and the media ID. This calculation may be made internally, for example, when the media key function value Km′ (or the media key Km) and the media ID are recorded.

Next, the aforementioned cases (1) to (3) are described in more detail.

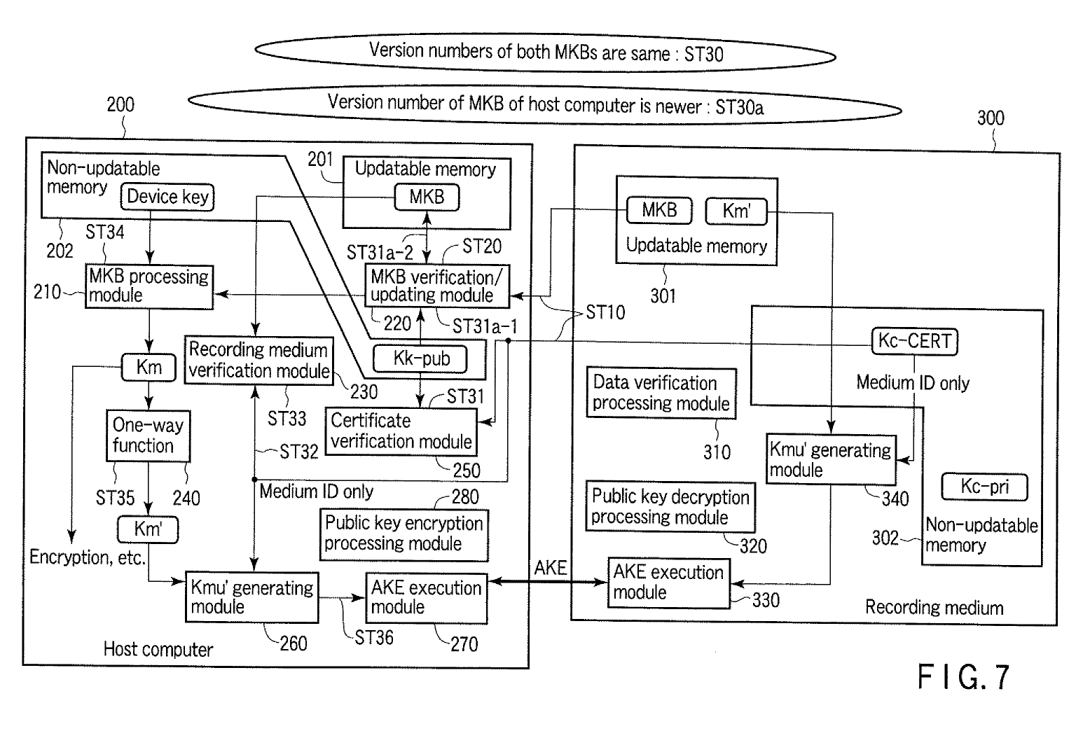

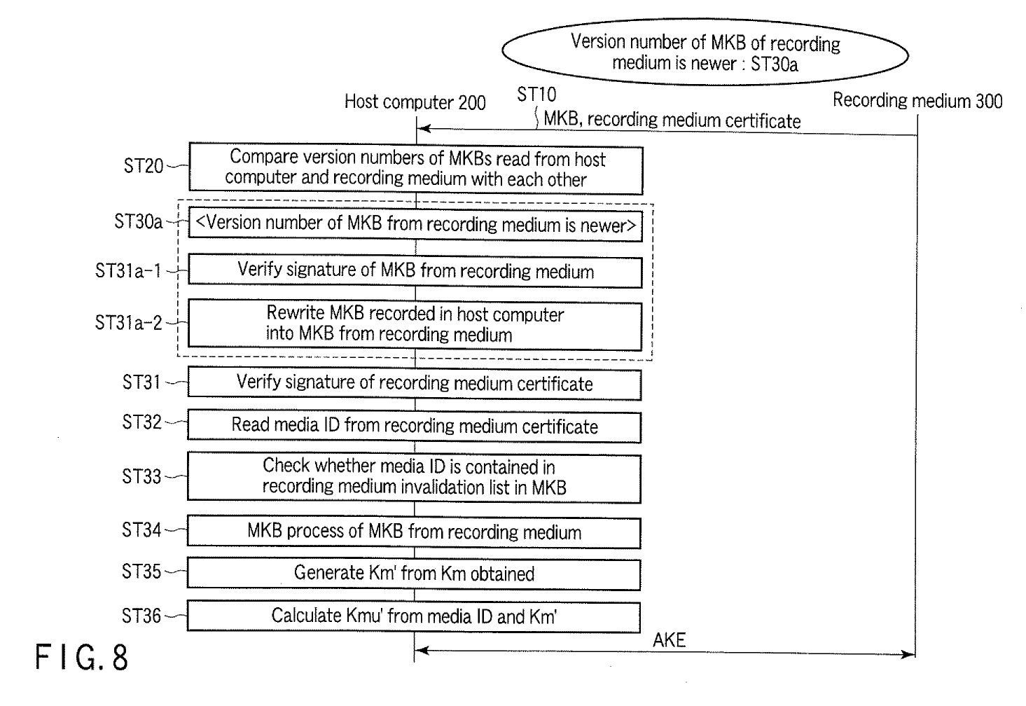

(1) In the case where the version numbers of the media key blocks MKB of the host computer 200 and the recording medium 300 are identical to each other (FIGS. 6 and 7)

The host computer 200 reads the media key block MKB in the updatable memory 301 and the recording medium certificate Kc-CERT in the non-updatable memory 302 from the recording medium 300 (ST10). Then, in the host computer 200, the MKB verification/updating module 220 compares the version number of the media key block MKB read from the recording medium 300 with the version number of the media key block MKB in the updatable memory 201 (ST20).

In the case where the comparison result shows that the two version numbers are identical (ST30), the media key blocks MKB are not updated.

Next, in the host computer 200, the certificate verification module 250 verifies the key generation center signature of the recording medium certificate Kc-CERT based on the center public key Kk-pub in the non-updatable memory 202 (ST31), and suspends the process in the case of a verification failure. In the case under consideration, however, the verification is assumed to be successful.

Once the verification succeeds, the recording medium verification module 230 reads the media ID from the recording medium certificate Kc-CERT (ST32) and judges whether the media ID is contained in the recording medium invalidation list of the media key block MKB in the updatable memory 201 or not (ST33).

In the case where the judgment in block ST33 shows that the media ID in the recording medium certificate Kc-CERT is contained in the recording medium invalidation list, the recording medium 300 is invalidated. In the case under consideration, however, the media ID is assumed not to be contained in the recording medium invalidation list. The invalidation process appropriately executable based on the application policy includes the case in which (a) the process continues to be executed, (2) the process is suspended or (3) the reading process is executed but not the writing process for the recording medium 300. The invalidation process of any one of (a) to (c), if predetermined, is executed by the host computer 200.

In the case where the judgment in block ST33 shows that the recording medium 300 is not to be invalidated, on the other hand, the MKB processing module 210 executes the MKB process of the media key block MKB from the recording medium 300 based on the device key Kd in the non-updatable memory 202 (ST34). The media key Km obtained by this MKB process is sent out to the one-way function calculation module 240.

The one-way function calculation module 240 generates the media key function value Km′ by calculating the one-way function of the media key Km (ST35) and sends out the media key function value Km′ to the Kmu′ generating module 260.

The Kmu′ generating module 260, based on the media ID and the media key function value Km′ in the recording medium certificate Kc-CERT, computes the one-way function “one way( )” thereby to generate the media unique key Kmu′=one way (Km′, media ID) (ST36). This media unique key Kmu′ is sent out from the Kmu′ generating module 260 to the AKE execution module 270.

The AKE execution module 270, based on this media unique key Kmu′, executes the AKE process with the AKE execution module 330 of the recording medium 300.

Incidentally, in the Kmu′ generating module 340 of the recording medium 300, as described above, the common media unique key Kmu′ used for AKE is computed by the one-way function from the media key function value Km′ and the media ID and input to the AKE execution module 330, for example, when the media key function value Km′ and the media ID are recorded. The AKE execution module 330 of the recording medium 300, therefore, can use the common media unique key Kmu′.

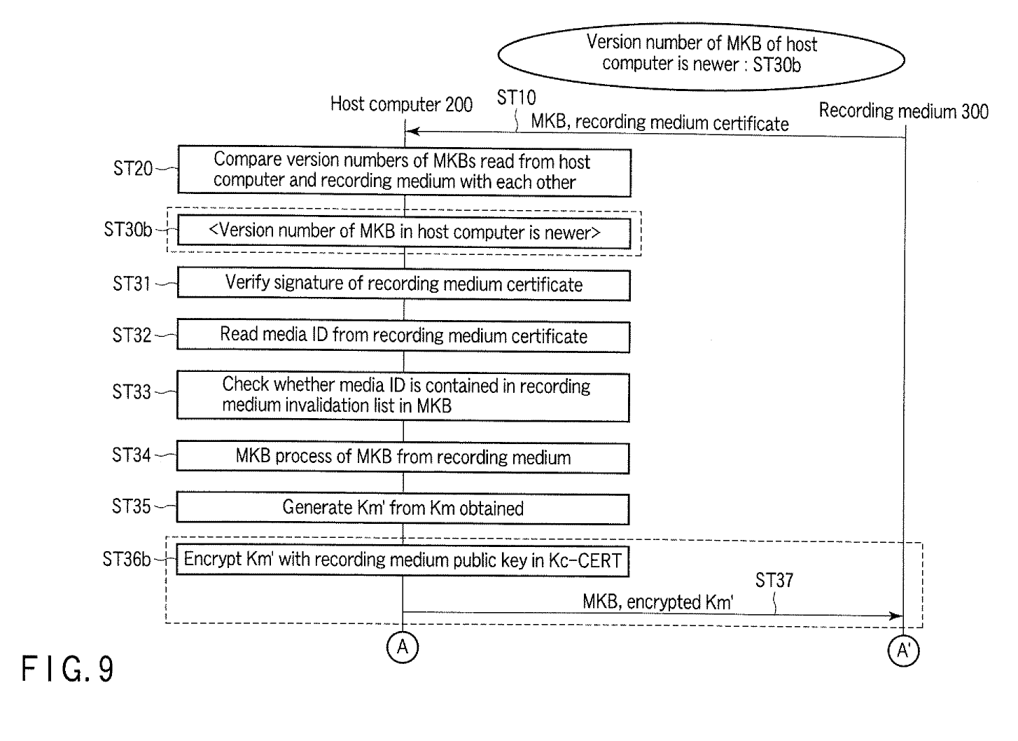

(2) In the case where the version number of the media key block MKB of the recording medium is newer than that of the host computer (FIGS. 8 and 7)

Assume that the host computer 200 executes blocks ST10 to ST20 as in the aforementioned case and the comparison executed in block ST20 shows that the version number of the media key block MKB from the recording medium 300 is newer (ST30a).

As in the preceding case, the host computer 200 executes the verification of block ST31 and suspends the process in the case of a verification failure. For the present purpose, however, assume that the verification is successful.

Once the verification ends in a success, the MKB verification/updating module 220, based on the center public key Kk-pub in the non-updatable memory 202, verifies the key generation center signature of the media key block MKB from the recording medium 300 (ST31a-1), and in the case of a failure, suspends the process. For the present purpose, however, assume that the verification is successful.

Once the verification in block ST31a-1 is successful, the MKB verification/updating module 220 rewrites the media key block MKB in the updatable memory 201 to the media key block MKB from the recording medium 300 (ST31a-2).

After this rewrite operation, the host computer 200, as in the case (1) described above, executes blocks ST32 to ST36, and then executes the AKE process.

(3) In the case where the version number of the media key block MKB of the host computer is newer than that of the recording medium (FIGS. 9 to 11)

Assume that the host computer 200 executes blocks ST10 to ST20 as in the preceding case and that the comparison in block ST20 shows that the version number of the media key block MKB in the host computer 200 is newer (ST30b).

In this case, the host computer 200, as in the case (1) described above, executes the process of blocks ST32 to ST35, and the one-way function calculation module 240 generates the media key function value Km′ (ST35). The one-way function calculation module 240 sends out the media key function value Km′ to the public key encryption processing module 280.

The public key encryption processing module 280 encrypts the media key function value Km′ with the recording medium public key Kc-pub in the recording medium certificate Kc-CERT (ST36b) and thus generates the encrypted media key function value Enc (Kc-pub, Km′) (expressed as the encrypted Km′ in the drawings).

After that, the host computer 200 sends the encrypted media key function value Enc (Kc-pub, Km′) and the media key block MKB in the updatable memory 201 to the recording medium 300 (ST37).

In the recording medium 300, upon receipt of the encrypted media key function value Enc (Kc-pub, Km′) and the media key block MKB, the data verification process module 310 compares the version number of the media key block MKB from the host computer 200 with that of the media key block MKB in the updatable memory 301 (ST38).

In the case where the comparison shows that the version number of the media key block MKB of the recording medium 300 is newer than or identical to the other version number, the process is suspended. The process is executed further, on the other hand, in the case where the version number of the media key block MKB of the host computer 200 is newer.

Next, the data verification process module 310, based on the center public key Kk-pub in the non-updatable memory 302, verifies the key generation center signature in the media key block MKB from the host computer 200 (ST39), and in the case of a verification failure, the process is suspended. An explanation is given below about a case in which the verification is successful.

Once the verification succeeds, the public key decryption process module 320 decrypts the encrypted media key function value Enc (Kc-pub, Km′) from the host computer 200 with the recording medium secret key Kc-pri in the non-updatable memory 302 (ST40). Then, the public key decryption process module 320 verifies the decrypted media key function value Km′ with the verification data Enc (Km′, fixed data) in the media key block MKB from the host computer 200 (ST41). In the verification in block ST41, the verification data Enc (Km′, fixed data) is decrypted based on the media key function value Km′ obtained by the decryption process of block ST40, and the fixed data obtained by the decryption is compared with the fixed data held in the public key decryption process module 320. In the case where both fixed data are coincident, the verification is judged as a success, and vice versa. In the case where the verification in block ST41 fails, the process is suspended. Nevertheless, the verification is assumed to be a success in the case under consideration.

Once the verification in block ST41 is successful, the data verification process module 310 rewrites the media key block MKB and the media key function value Km′ in the updatable memory 301 to the media key block MKB and the media key function value Km′, respectively, received from the host computer 200 (ST42). The Kmu′ generating module 340 generates the media unique key Kmu′ by arithmetic operation of the one-way function of the media key function value Km′ after the rewrite operation in block ST42 and the media ID in the recording medium certificate Kc-CERT in the non-updatable memory 302.

The host computer 200, on the other hand, returns the process to block ST10 and executes it again after data transmission in block ST37. In the case where the updating of the recording medium 300 is successful, the version numbers are identical as the result of comparison in block ST20, the process (1) [In the case where the version numbers of the media key blocks MKB of the host computer 200 and the recording medium 300 are identical] is executed. In the case where the process is suspended in the recording medium 300, on the other hand, the information on the process suspension may be notified to the host computer 200 as a message.

As explained above, according to this embodiment, in the case where the version number of the media key block MKB from the recording medium 300 is newer than that of the media key block MKB in the host computer 200, the host computer executes the process other than AKE and thus reduces the load on the recording medium while at the same time maintaining the existing mechanism of removing the illegal devices by verifying the recording medium certificate Kc-CERT and the media key block MKB and confirming the recording medium invalidation list. As a result, the load of the mutual authentication process between the recording medium and the host computer can be reduced.

Also, in the case where the version number of the media key block MKB in the host computer 200 is newer than that of the media key block MKB from the recording medium 300, the host computer executes the encryption process according to the public key encryption scheme and the recording medium executes the decryption process according to the public key encryption scheme while at the same time maintaining the existing mechanism of removing the illegal devices by verifying the recording medium certificate KC-CERT and the media key block MKB and confirming the recording medium invalidation list. As compared with the conventional method in which both the host computer and the recording medium execute the encryption process and the decryption process, therefore, the load on the recording medium is reduced, and so is the load of the mutual authentication process between the recording medium and the host computer.

Further, a method can be realized in which the media key block MKB of the host computer 200 and the recording medium 300 is updated to the newest one while at the same time reducing the computation process on the part of the recording medium 300.

Also, the newest media key block MKB is held in the recording medium 300 and the host computer 200, and the host computer 200 judges whether the media key block MKB is to be updated or not. In this way, either the media key block MKB of the host computer 200 or the media key block MKB of the recording medium 300 is updated.

Further, the data legitimacy can be confirmed and the mutual authentication process between the host computer 200 and the recording medium 300 can be executed using the media key block MKB while at the same time reducing the computation process in the recording medium 300.

### Second Embodiment

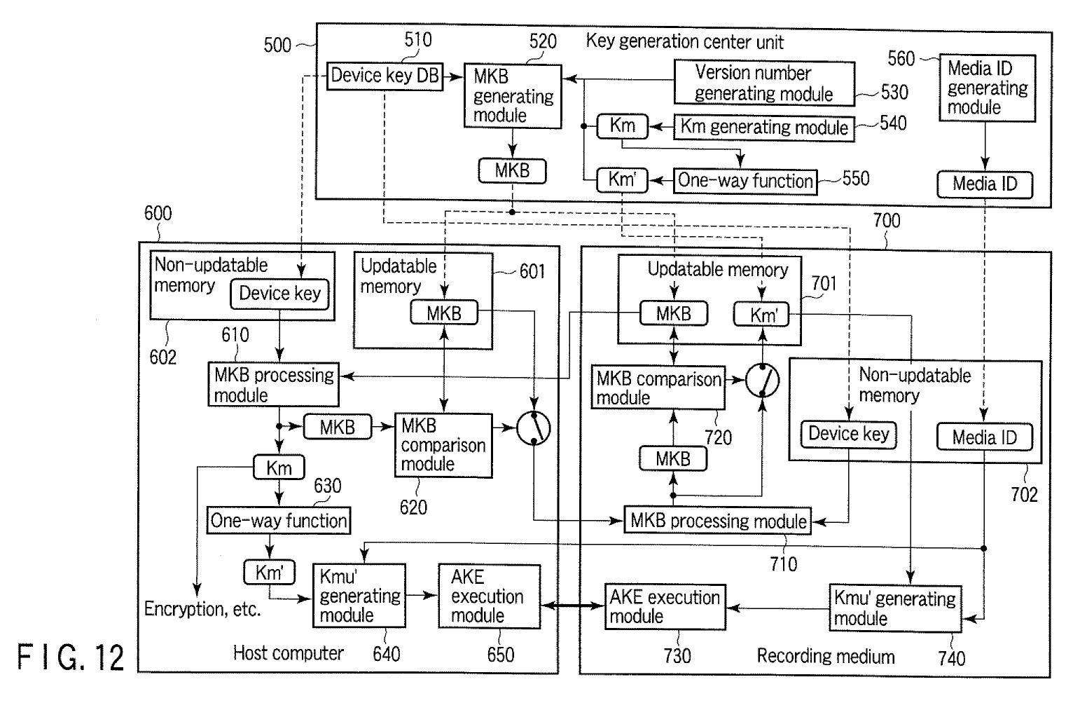

FIG. 12 is a diagram showing a general configuration of the authentication system according to a second embodiment of the invention. This authentication system is configured of a key generation center unit 500, a host computer 600 and a recording medium 700. Although the whole system is actually configured of one key generation center unit, plural host computers and plural recording media, the explanation that follows deals with a configuration including one host computer and one recording medium as a typical example.

The key generation center unit 500 includes a device key DB 510, an MKB generating module 520, a version number generating module 530, a Km generating module 540, a one-way function calculation module 550 and a media ID generating module 560. Incidentally, the one-way function calculation module 550 may be omitted, in which case the updatable memory 702 of the recording medium 700 stores the media key Km.

The device key DB (Database) 510 is a random access memory unit that can be read from or written into for holding the device keys Kd_h1 to Kd_hx and Kd_c1 to Kd_cy generated in advance. Incidentally, the device keys Kd_h1 to Kd_hx having the affix h are used for the host computer 600, while the device keys Kd_c1 to Kd_cy having the affix c are used for the recording medium 700.

The MKB generating module 520 has the function of, upon receipt of the version number from the version number generating module 530, calculating the exclusive logic sum xor between the media key Km and the particular version number thereby to obtain the media key xor value, the function of encrypting the media key xor value based on the device keys Kd_h1 to Kd_hx in the device key DB 510 and generating the encrypted media key xor value Enc (Kd_h1, Km xor version number), . . . , Enc (Kd_hx, Km xor version number), the function of receiving the media key function value Km′ from the one-way function calculation module 550, the function of obtaining the media key function xor value by calculating the exclusive logic sum xor between the media key function value Km′ and the version number, the function of encrypting the media key function xor value based on the device keys Kd_c1 to Kd_cy in the device key DB 510 and generating the encrypted media key function xor value Enc (Kd_c1, Km′ xor version number), . . . , Enc (Kd_cy, Km′ xor version number), and the function of generating the media key block MKB including the version number, the verification data, the encrypted media key xor value and the encrypted media key function xor value.

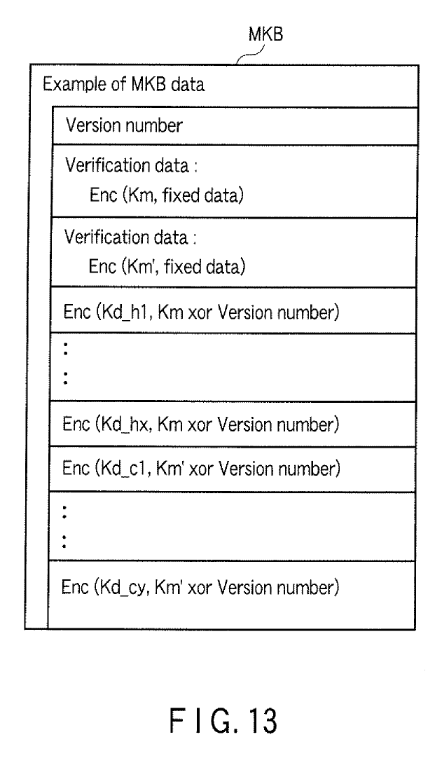

The media key block MKB according to this embodiment, unlike in the first embodiment, does not include the recording medium invalidation list and the key generation center signature, and instead includes, as shown in FIG. 13, the version number, the verification data, the encrypted media key xor value and the encrypted media key function xor value.

The version number, the verification data Enc (Km, fixed data) and Enc (Km′, fixed data) are described above.

The encrypted media key xor values Enc (Kd_h1, Km xor version number), . . . , Enc (Kd_hx, Km xor version number) are the media key xor values (Km xor version numbers) encrypted by the predetermined device keys Kd_h1, . . . , Kd_hx. The media key xor value is the result of calculation of the exclusive logic sum between the media key Km and the version number, and can be restored by decrypting the encrypted media key xor value using the device keys Kd_h1, . . . , Kd_hx. The media key Km can be restored as the result of calculation of the exclusive logic sum between the media key xor value (Km xor version number) and the version number.

The encrypted media key function xor value Enc (Kd_c1, Km′ xor version number), . . . , Enc (Kd_cx, Km′ xor version number) are the media key function xor value (Km′ xor version number) encrypted by the predetermined device keys Kd_c1, . . . , Kd_cy. The media key function xor value is the result of calculation of the exclusive logic sum between the media key function value Km′ and the version number, and can be restored by decrypting the encrypted media key function xor value using the device keys Kd_c1, . . . , Kd_cy. The media key function Km′ can be restored as the result of calculation of the exclusive logic sum between the media key function xor value (Km′ xor version number) and the version number.

Specifically, the feature of the media key block MKB according to this embodiment is that as described later, both the media key Km and the media key function value Km′ can be derived from the device key Kd_h stored in the host computer 600, while only the media key function value Km′ can be derived from the device key Kd_c stored in the recording medium 700.

Incidentally, the correct media key Km cannot be derived from the device keys Kd_h1, . . . , Kd_hx associated with what is recognized as an illegal host computer. Further, the correct media key function value Km′ cannot be derived from the device key Kd_c associated with what is recognized as an illegal recording medium.

The version number generating module 530 has the function of generating, upon receipt of a version number generation request from the MKB processing module 520, the newest version number of the media key block MKB and sends it out to the MKB generating module 520.

The Km generating module 540 has the function of generating the media key Km by random number generation and the function of sending out the particular media key Km to the MKB generating module 520 and the one-way function calculation module 550.

The one-way function calculation module 550 has the function of arithmetic operation of the one-way function of the media key Km received from the Km generating module 540 and calculating the media key function value Km′ as the result of arithmetic operation and the function of sending out the media key function value Km′ to the MKB generating module 520. Incidentally, the media key function value Km′ may also be called the media key hash value Km′.

The media ID generating module 560, as described above, has the function of generating the media ID in such a manner as not to duplicate a media ID generated in the past, by issuing the serial number or the like.

The host computer 600 includes an updatable memory 601, a non-updatable memory 602, an MKB processing module 610, an MKB comparison module 620, a one-way function calculation module 630, a Kmu′ generating module 640 and an AKE execution module 650. Incidentally, the one-way function calculation module 630 may be omitted, in which case the media key Km is used in place of the media key function value Km′ on the one hand and the media unique key Kmu=one way (Km, media ID) is used in place of the media unique key Kmu′=one way (Km′, media ID) on the other hand.

The updatable memory 601 is an updatable random access memory that can be read from or written into by the modules 610 to 650, and holds the media key block MKB. The word “updatable” is defined as a state in which the media key block MKB can be rewritten as described above.

The non-updatable memory 602, readable from the modules 610 to 650 and updatable, holds one device key Kd_h. Incidentally, the one device key Kd_h may be any one of the x device keys Kd_h1 to Kd_hx. Also, the word “non-updatable” is defined as a state in which the device keys and the media ID cannot be rewritten.

The MKB processing module 610 has the function of executing the MKB process on the media key block MKB from the recording medium 700 based on the device key Kd_h in the non-updatable memory 602, the function of sending out the media key block MKB from the recording medium 700 to the MKB comparison module 620, and the function of sending out the media key Km obtained by the MKB process to the one-way function calculation module 240.

The MKB comparison module 620 has the function of comparing the version number of the media key block MKB of the recording medium 700 received from the MKB processing module 610 with the version number of the media key block MKB in the updatable memory 601, the function of not executing the updating process for the media key block MKB in the case where the comparison result shows that both version numbers are identical or the version number of the media key block MKB in the updatable memory 201 is newer, and the function of rewriting the media key block MKB in the updatable memory 601 to the media key block MKB from the recording medium 700 in the case where the comparison result shows that the version number of the media key block MKB read from the recording medium 700 is newer.

The one-way function calculation module 630 has the function of generating the media key function value Km′ by the arithmetic operation of the one-way function of the media key Km sent out from the MKB processing module 610, and the function of sending out the media key function value Km′ to the Kmu′ generating module 640.

The Kmu′ generating module 640 has the function of generating the media unique key Kmu′=one way (Km′, media ID) by calculating the one-way function “one way( )” based on the media ID read from the recording medium 700 and the media key function value Km′ received from the one-way function calculation module 630 and the function of sending out the media unique key Kmu′ to the AKE execution module 650.

The AKE execution module 650 has the function of executing the AKE process with the recording medium 700 based on the media unique key Kmu′ received from the Kmu′ generating module 640.

The recording medium 700 includes an updatable memory 701, a non-updatable memory 702, an MKB processing module 710, an MKB comparison module 720, an AKE execution module 730 and a Kmu′ generating module 740.

The updatable memory 701, which is an updatable random access memory that can be read from or written into by the modules 710 to 740, holds the media key block MKB and the media key function value Km′. Incidentally, the media key function value Km′ may be replaced with the media key Km. The word “updatable” is defined as a state in which the media key block MKB and the media key function value Km′ can be rewritten.

The non-updatable memory 702, which cannot be updated and can be read by the modules 710 to 740, holds the device key Kd_c and the media ID. The word “non-updatable” is defined as a state in which the device key Kd_c and the media ID cannot be rewritten.

The MKB processing module 710 has the function of executing the MKB process on the media key block MKB from the host computer 600 based on the device key Kd_c in the non-updatable memory 702, the function of sending out the media key block MKB from the recording medium 700 to the MKB comparison module 720, the function of decrypting, with the device key Kd_c in the non-updatable memory 702, the encrypted media key function xor vale Enc (Kd_c, Km′ xor version number) in the media key block MKB from the host computer 600 in the case where the comparison result by the MKB comparison module 720 shows that the version number of the media key block MKB of the host computer 600 is newer, the function of calculating the exclusive logic sum between the decrypted media key function xor value and the version number in the media key block MKB of the host computer 600 and obtaining the media key function value Km′ by this calculation, the function of verifying the media key function value Km′ using the verification data Enc (Km′, fixed data) in the media key block MKB from the host computer 600, and the function of rewriting the media key block MKB and the media key function value Km′ in the updatable memory 701 to the media key block MKB received from the host computer 600 and the media key function value Km′ obtained from the particular media key block MKB, respectively, in the case where the verification is successful. Incidentally, in the case where the one-way function calculation modules 550, 630 are omitted, the encrypted media key xor value Enc (Kd_c, Km xor version number), the media key Km and the verification data Enc (Km, fixed data) are used in place of the encrypted media key function xor value Enc (Kd_c, Km′ xor version number), the media key function value Km′ and the verification data Enc (Km′, fixed data), respectively.

The MKB comparison module 720 has the function of comparing the version number of the media key block MKB of the host computer 600 received from the MKB processing module 710 with the version number of the media key block MKB in the updatable memory 701 and the function of sending out the result of comparison to the MKB processing module 710.

The AKE execution module 730 has the function of executing the AKE process with the host computer 600 based on the media unique key Kmu′ received from the Kmu′ generating module 740.

The Kmu′ generating module 740 has the function of generating the media unique key Kmu′ by the arithmetic operation of the one-way function of the media key function value Km′ in the updatable memory 701 after the rewrite operation of the MKB processing module 710 and the media ID in the non-updatable memory 702, and the function of sending out the media unique key Kmu′ to the AKE execution module 73C. Incidentally, in the case where the one-way function calculation modules 550, 630 are omitted, the media key Km and the media unique key Kmu are used in place of the media key function value Km′ and the media unique key Kmu′, respectively.

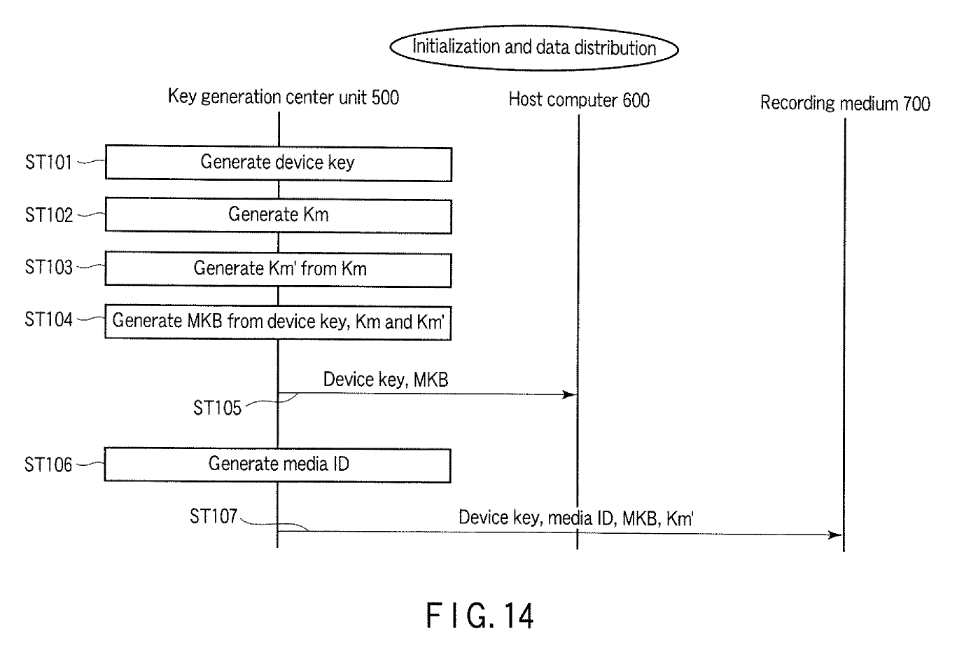

Next, the operation of the authentication system configured as described above is explained with reference to FIGS. 14 to 20. First, the key generation center unit 500 carries out the initialization and the distribution of the key and other data. The host computer maker and the recording medium maker record the data distributed from the key generation center unit 500 in the host computer 600 and each recording medium 700, respectively. Nevertheless, the data including the key may alternatively be recorded in the host computer 600 and each recording medium 700 by the key generation center unit 500. Also, the host computer 600 and the recording medium 700 are each distributed and acquired by the user thereby to execute the authentication process between the host computer and the recording medium on the part of the user. This process is sequentially explained below.

(Initialization and Data Distribution)

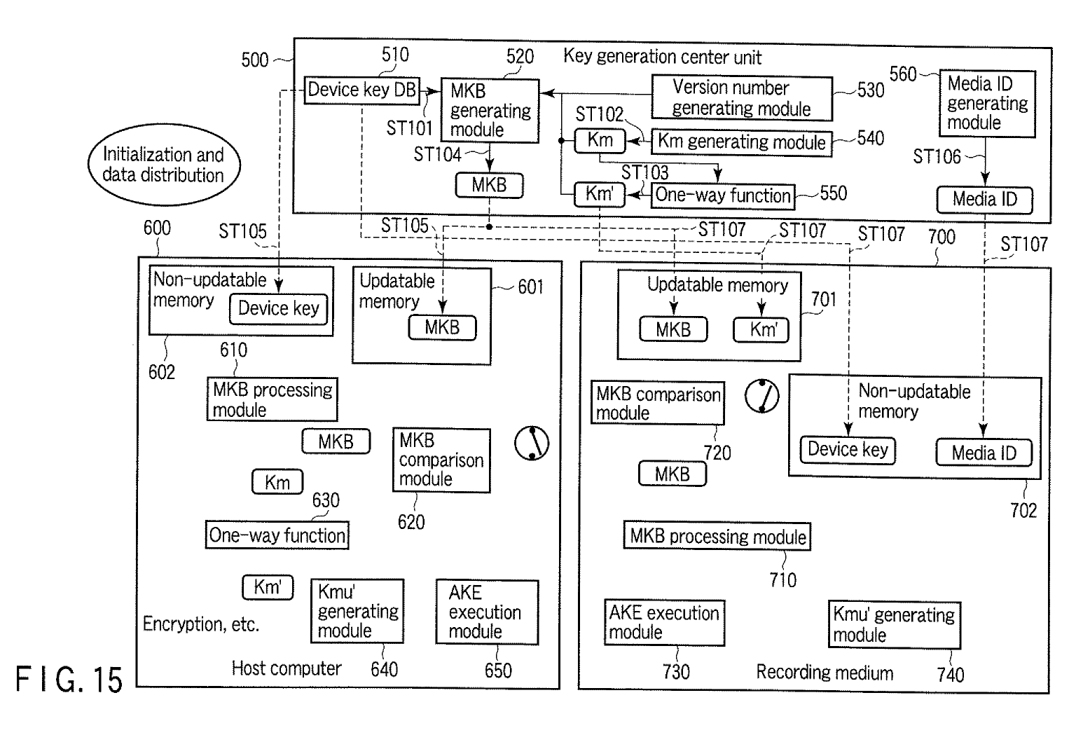

The key generation center unit 500, as shown in FIGS. 14 and 15, generates the device keys Kd including those (Kd_h1 to Kd_hx, Kd_c1 to Kd_cy) for future use by the authentication system (ST101) and holds these device keys Kd_h1 to Kd_hx, Kd_c1 to Kd_cy in the device key DR.

Also, in the key generation center unit 500, the Km generating module 540 generates a random number as a media key Km (ST102), and sends out the media key Km to the MKB generating module 520 and the one-way function calculation module 550. Incidentally, this random number may be given from an external source.

The one-way function calculation module 550 calculates the one-way function based on this media key Km thereby to generate the media key function value Km′ (ST103), and sends out this media key function value Km′ to the MKB generating module 520.

The MKB generating module 520 sends out a version number generation request to the version number generating module 530. The version number generating module 530, upon receipt of the version number generation request, generates the MKB version number and sends it out to the MKB generating module 520.

Next, the MKB generating module 520, upon receipt of the version number, calculates the exclusive logic sum xor between the media key Km and the particular version number thereby to obtain the media key xor value.

The MKB generating module 520, based on the device keys Kd_h1 to Kd_hx in the device key DB 510, encrypts the media key xor value and generates the encrypted media key xor values Enc (Kd_h1, Km xor version number), . . . , Enc (Kd_hx, Km xor version number).

In a similar fashion, the MKB generating module 520 calculates the exclusive logic sum xor of the media key function value Km′ and the version number and thus obtains the media key function xor value.

The MKB generating module 520, based on the device keys Kd_c1 to Kd_cy in the device key DB 510, encrypts the media key function xor value and thus generates the encrypted media key function xor values Enc (Kd_c1, Km′ xor version number), . . . , Enc (Kd_cy, Km′ xor version number).

Further, the MKB generating module 520 encrypts predetermined unique data with the media key Km and the media key function value Km′ thereby to generate the verification data Enc (Km, fixed data) and Enc (Km′, fixed data), respectively.

After that, the MKB generating module 520, as shown in FIG. 13, generates the media key block MKB including the version number, the verification data, the encrypted media key xor value and the encrypted media key function xor value (ST104).

Any one device key Kd_h of the device keys Kd_h1 to Kd_hx and the media key block MKB are written in the updatable memory 601 or the non-updatable memory 602 of the host computer 600 through the host computer maker (ST105). Incidentally, the manner in which the device key is assigned is determined from the viewpoint of system application as described above. Also, the media key block MKB, as described above, may be downloaded from the key generation center unit 500 and written in the host computer 600 by the user.

Now, the steps of generating the data to be stored in the recording medium 700 are explained.

In the key generation center unit 500, the media ID generating module 560 generates the media ID by issuing the serial numbers or the like (ST106). Incidentally, the media ID may alternatively be acquired from an external source instead of being generated in the key generation center unit 500.

The aforementioned any one device key Kd_c of the device keys Kd_c1 to Kd_cy, the media ID, the media key block MKB and the media key function value Km′ corresponding to the media key block MKB are written in the updatable memory 701 or the non-updatable memory 702 of the recording medium 700 through the recording medium maker (ST107). Incidentally, the media unique key Kmu′ calculated in advance may be used in place of the media key function value Km′.

(Authentication Between Host Computer and Recording Medium)

First, an outline is described.

The authentication operation between the host computer 600 and the recording medium 700, as described above, is varied with the result (1) to (3) of the comparison between the version number of the media key block MKB in the host computer 600 and the version number of the media key block MKB in the recording medium 700. Also, after the end of the MKB update process, the authentication process and key exchange process AKE are executed in the same manner as described above.

Now, the cases (1) to (3) described above are explained in more detail.

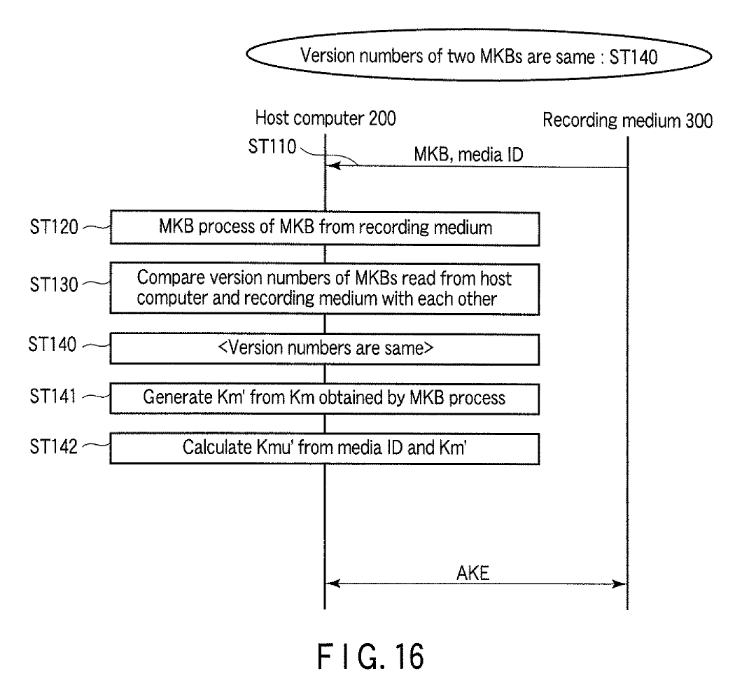

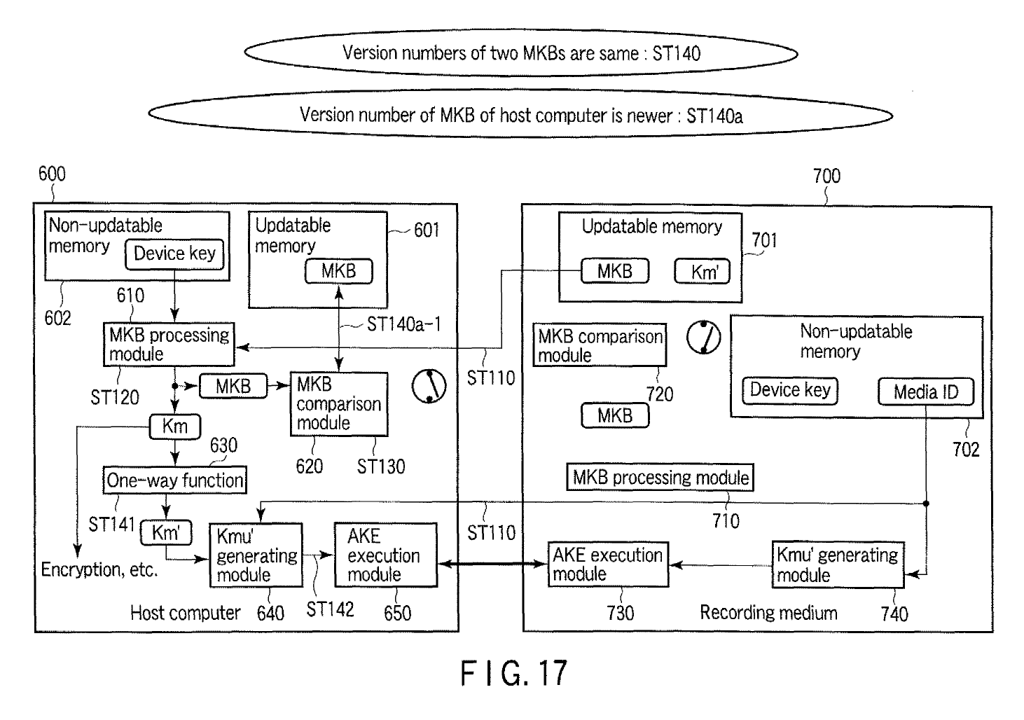

(1) The case in which the version numbers of the media key blocks MKB of the host computer 600 and the recording medium 700 are identical to each other (see FIGS. 16 and 17).

The host computer 600 reads the media key block MKB in the updatable memory 701 and the media ID in the non-updatable memory 702 from the recording medium 700 (ST110).

Then, in the host computer 600, the MKB processing module 610 processes the media key block MKB from the recording medium 700 based on the device key Kd_h in the non-updatable memory 602 (ST120) and sends out the media key block MKB from the recording medium 700 to the MKB comparison module 620.

The MKB comparison module 620 compares the version number of the media key block MKB of the recording medium 700 with the version number of the media key block MKB in the updatable memory 601 (ST130).

In the case where the comparison shows that the two version numbers are identical to each other (ST140), the media key block MKB is not updated.

Next, in the host computer 600, the media key Km obtained by the MKB process in block ST120 is sent out to the one-way function calculation module 630 by the MKB processing module 610.

The one-way function calculation module 630 generates the media key function value Km′ by the arithmetic operation of the one-way function of the media key Km (ST141), and sends out the particular media key function value Km′ to the Kmu′ generating module 640.

The Kmu′ generating module 640 calculates the one-way function “one way( )” based on the media ID read from the recording medium 700 and the media key function value Km′ thereby to generate the media unique key Kmu′=one way (Km′, media ID) (ST142). This process can be omitted in the case where the media unique key Kmu′ is recorded in advance. This media unique key Kmu′ is sent out to the AKE execution module 650 from the Kmu′ generating module 640.

The AKE execution module 650, based on the media unique key Kmu′, executes the AKE process with the AKE execution module 730 of the recording medium 700.

Incidentally, the Kmu′ generating module 740 of the recording medium 700, as described above, calculates the common media unique key Kmu′ for AKE from the media key function value Km′ and the media ID and inputs them to the AKE execution module 330. As a result, the AKE execution module 730 of the recording medium 700 can use the common media unique key Kmu′.

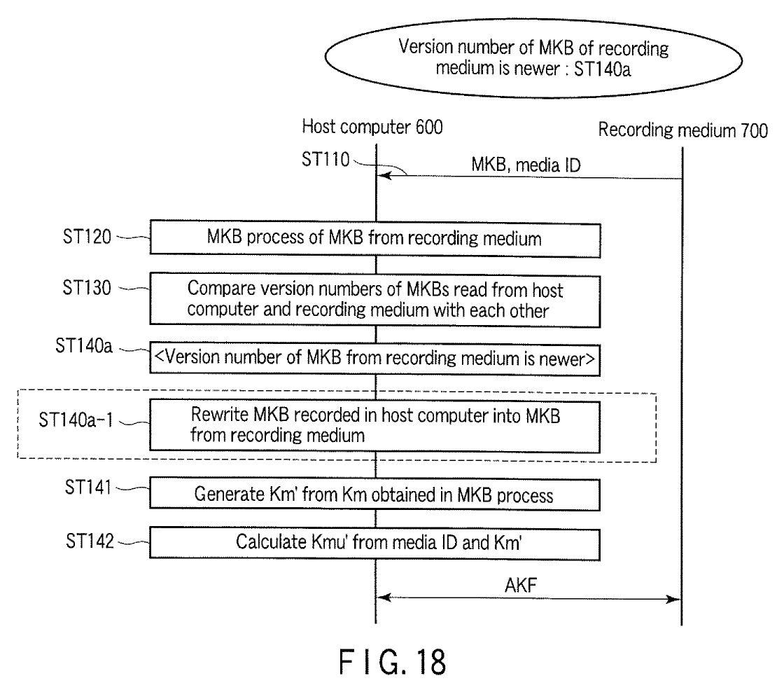

(2) The case in which the version number of the media key block MKB of the recording medium is newer than that of the host computer (see FIGS. 18 and 17).

Assume that, as described above, the host computer 600 executes blocks ST110 to ST130 and the comparison in block ST130 shows that the version number of the media key block MKB from the recording medium 700 is newer (ST140a).

In this case, the MKB comparison module 620 rewrites the media key block MKB in the updatable memory 601 to the media key block MKB from the recording medium 700 (ST140a-1).

After this rewrite operation, the host computer 600, as described in (1), executes both the process of blocks ST141 to ST142 and the AKE process.

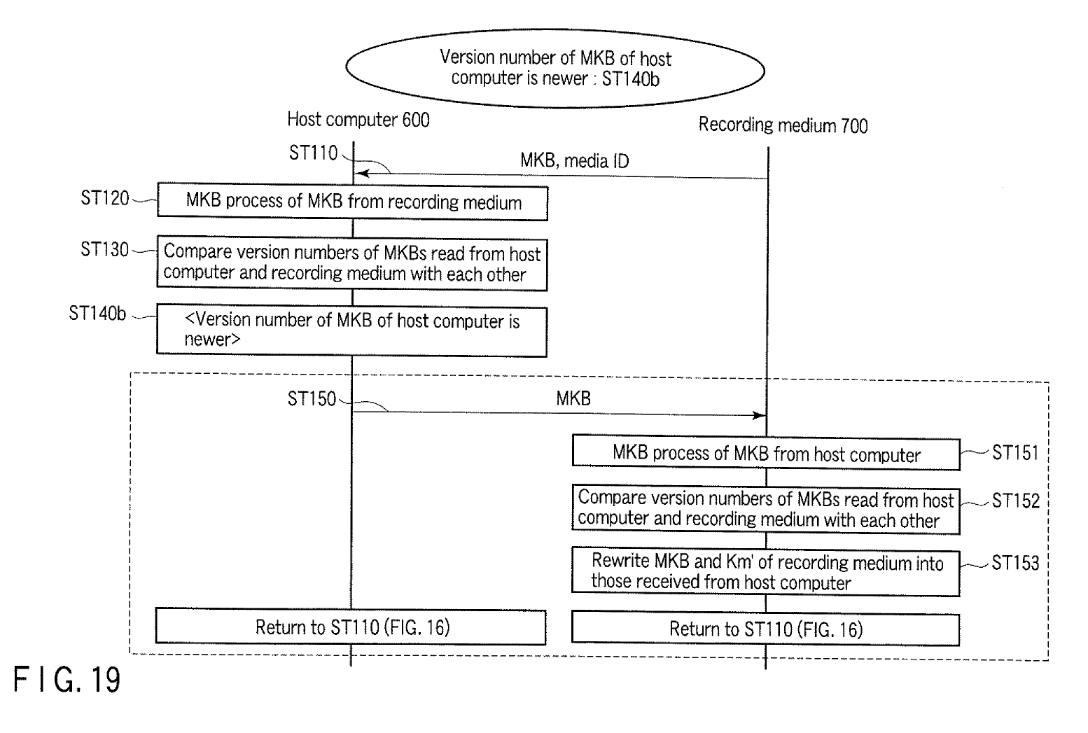

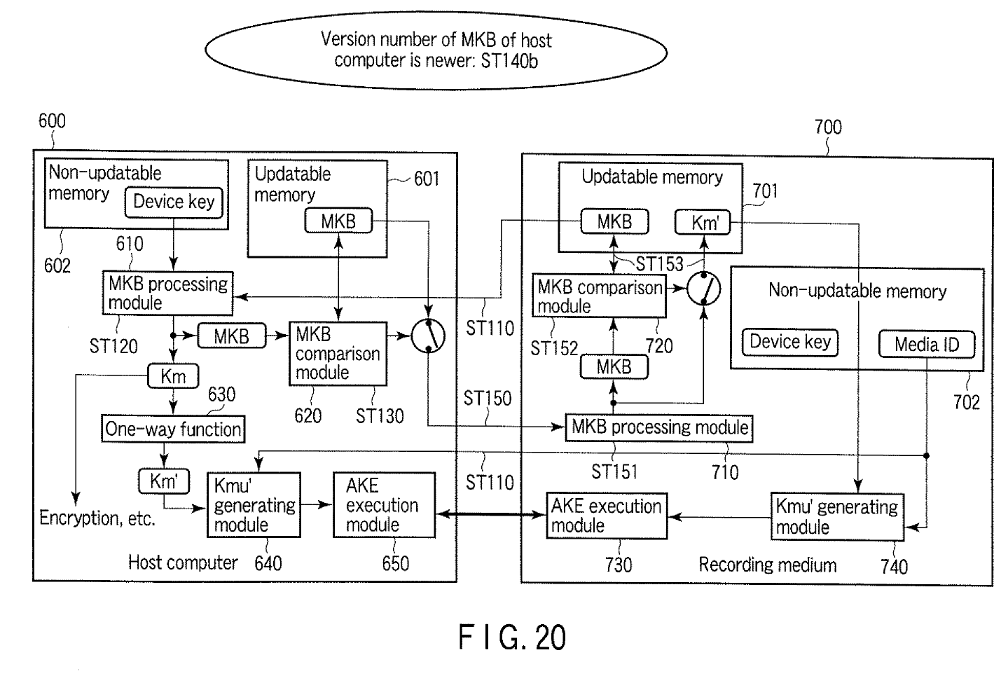

(3) The case in which the version number of the media key block MKB of the host computer is newer than that of the recording medium (see FIGS. 19 and 20).

Assume that the host computer 600, in the same manner as described above, executes blocks ST110 to ST130 and the comparison in block ST130 shows that the version number of the media key block MKB in the host computer 600 is newer (ST140b).

In this case, the host computer 600 transmits the media key block MKB in the updatable memory 601 to the recording medium 700 (ST150).

In the recording medium 700, upon receipt of the media key block MKB, the MKB processing module 710 processes the media key block MKB from the host computer 600 based on the device key Kd_c in the non-updatable memory 702 (ST151) and sends out the media key block MKB from the recording medium 700 to the MKB comparison module 720.

The MKB comparison module 720 compares the version number of the media key block MKB from the host computer 600 with the version number of the media key block MKB in the updatable memory 701 (ST152) and sends out the comparison result to the MKB processing module 710.

In the case where the comparison shows that the version number of the media key block MKB of the recording medium 700 is newer or identical, the process is suspended. In the case where the version number of the media key block MKB of the host computer 600 is newer, on the other hand, the process is advanced.

In the case where the version number of the media key block MKB of the host computer 600 is newer, the MKB processing module 710 can execute any of four processes (1) to (4) described below in accordance with the format of the media key block MKB.

(1) In the case of the media key block MKB shown in FIG. 13, the process of determining the media key function value Km′ by the decryption and the xor operation of the encrypted media key function xor value Enc (Kd_c, Km′ xor version number) in the media key block MKB and the process of verifying the determined media key function value Km′ with the verification data Enc (Km′, fixed data) in the media key block MKB.

(2) In the case where the encrypted media key function reversible computation value Enc (Kd_c, Km′+version number) is used in place of the encrypted media key function xor value Enc (Kd_c, Km′ xor version number) shown in FIG. 13, the process of determining the media key function value Km′ by the decryption process and the reversible operation (for example, subtraction “−” against addition “+”) from the encrypted media key function reversible computation value Enc (Kd_c, Km′+version number) and the process of verifying the determined media key function value Km′ with the verification data Enc (Km′, fixed data) in the media key block MKB. Incidentally, the reversible operation is not limited to the subtraction “−” against the addition “+” or the inverse thereof (the addition “+” against the subtraction “−”), and any operation is applicable. The exclusive logic sum of (1) above is also an example of the reversible operation.

(3) In the case where the encrypted media key function xor value Enc (Kd_c, Km′ xor version number∥version number) encrypted from the concatenated data with the version number concatenated to the media key function xor value is used in place of the encrypted media key function xor value Enc (Kd_c, Km′ xor version number) shown in FIG. 13, the process of determining the concatenated data “Km′ xor version number∥version number” by the decryption of the encrypted media key function xor value Enc (Kd_c, Km′ xor version number∥version number), the process of comparing the “version number” of a part of the concatenated data with the version number in the media key block MKB and confirming that the comparison shows the coincidence of the version numbers and that the version number is not altered, the process of subsequently determining the media key function value Km′ by the xor operation similar to (1) above, and the process of verifying the determined media key function value Km′ with the verification data Enc (Km′, fixed data) in the media key block MKB.

(4) In the case where the verification data Enc (Km′, fixed data∥version number) encrypted from the concatenated data with the version number concatenated to the fixed data is used in place of the verification data Enc (Km′, fixed data) shown in FIG. 13, the process of determining the media key function value Km′ in the same manner as in the case (1) or (2), the process of decrypting the verification data Enc (Km′, fixed data∥version number) in the media key block MKB based on the media key function value Km′ thus determined, the process of comparing the “version number” of a part of the decrypted concatenated data of “fixed data∥version number” with the version number in the media key block MKB and confirming that the comparison shows the coincidence of the version numbers and that the version number is not altered, and the process of subsequently verifying the “fixed data” constituting a part of the concatenated data.

The case described below concerns the execution of the process (1).

Next, the MKB processing module 710 decrypts the encrypted media key function xor value Enc (Kd_c, Km′ xor version number) in the media key block MKB from the host computer 600 with the device key Kd_c in the non-updatable memory 702. Then, the MKB processing module 710 calculates the exclusive logic sum of the decrypted media key function xor value and the version number in the media key block MKB from the host computer 600 thereby to obtain the media key function value Km′.

After that, the MKB processing module 710 verifies the media key function value Km′ with the verification data Enc (Km′, fixed data) in the media key block MKB from the host computer 600. In this verification, as described above, the verification data Enc (Km′, fixed data) is decrypted based on the media key function value Km′ obtained by decryption, and the fixed data obtained by this decryption process is compared with the fixed data held in the MKB processing module 710. Thus, the verification is judged as a success in the case where the two pieces of fixed data are coincident and as a failure otherwise.

Once the verification is successful, the MKB processing module 710 rewrites the media key block MKB and the media key function value Km′ in the updatable memory 701 to the media key block MKB received from the host computer 600 and the media key function value Km′ obtained from this particular media key block MKB, respectively (ST153). The Kmu′ generating module 740 generates the media unique key Kmu′ by arithmetic operation of the one-way function of the media key function value Km′ after the rewrite operation in block ST153 and the media ID in the non-updatable memory 702.

In the case where this verification ends in a failure, the recording medium 700 suspends the process of updating the media key block MKB. Specifically, the device key Kd_c held in the non-updatable memory 702 of the recording medium 700 is removed as an illegal recording medium, and therefore, the media key block MKB cannot be updated. Incidentally, whether the following AKE process is to be executed or not is appropriately determined according to the operation policy such as (l) the process is continued as it is, (b) the process is suspended, or (3) the recording medium 700 is read from but not written into.

The host computer 600, on the other hands returns to and executes the process of block ST110 after data transmission in block ST150. In the case where the recording medium 700 is successfully updated, the result of the comparison in block ST130 for re-execution shows that the two version numbers are identical to each other, and therefore, the process of (1) “The case in which the version numbers of the media key blocks MKB of the host computer 600 and the recording medium 700 are identical to each other” is executed. In the case where the process in the recording medium 700 is suspended, on the other hand, the information on the process suspension may be notified to the host computer 600 as a message.

As described above, according to this embodiment, in the case where the version number of the media key block MKB from the recording medium 700 is newer than the version number of the media key block MKB in the host computer 600, the load on the recording medium is reduced by the host computer executing the process other than AKE while maintaining the existing mechanism for removing the illegal devices of the MKB process of the media key block MKB with the device key Kd_h, and therefore, the load of the mutual authentication process between the recording medium and the host computer is reduced.

In a similar fashion, in the case where the version number of the media key block MKB in the host computer 600 is newer than the version number of the media key block MKB from the recording medium 700, the load on the recording medium is reduced as compared with the conventional case in which the encryption and decryption processes according to the public key encryption scheme are executed on both sides while maintaining the existing mechanism for removing the illegal devices of the MKB process of the media key block MKB with the device key Kd_h, and therefore, the load of the mutual authentication process between the recording medium and the host computer is reduced.

Also, a method can be realized in which the computation process on the part of the recording medium 700 is reduced while at the same time updating the media key blocks MKB of the host computer 600 and the recording medium 700 to the newest one.

Further, both the recording medium 700 and the host computer 600 hold the newest media key block MKB, and judge whether the media key block MKB of the host computer 600 should be updated. The process is executed such that the media key block MKB of the host computer 600 is updated or the media key block MKB of the recording medium 700 is updated.

Furthermore, by executing the mutual authentication process using the media key block MKB while reducing the computation process on the part of the recording medium 700, the data legitimacy and the authentication of the host computer 600 and the recording medium 700 can be achieved at the same time.

The technique described above for the embodiment can be stored as a program to be executed by a computer in memory mediums including magnetic disks (Floppy™ disks, hard disks, etc.), optical disks (CD-ROMs, DVDs, etc.), magneto-optical disks (MOs) and semiconductor memories for distribution.

Memory mediums that can be used for the purpose of the present invention are not limited to those listed above and memory mediums of any type can also be used for the purpose of the present invention so long as they are computer-readable ones.

Additionally, the operating system (OS) operating on a computer according to the instructions of a program installed in the computer from a memory medium, data base management software and/or middleware such as network software may take part in each of the processes for realizing the above embodiment.

Still additionally, memory mediums that can be used for the purpose of the present invention are not limited to those independent from computers but include memory mediums adapted to download a program transmitted by LANs and/or the Internet and permanently or temporarily store it.

It is not necessary that a single memory medium is used with the above described embodiment. In other words, a plurality of memory mediums may be used with the above-described embodiment to execute any of the above described various processes. Such memory mediums may have any configuration.

For the purpose of the present invention, a computer executes various processes according to one or more than one programs stored in the memory medium or mediums as described above for the preferred embodiment. More specifically, the computer may be a stand alone computer or a system realized by connecting a plurality of computers by way of a network.

For the purpose of the present invention, computers include not only personal computers but also processors and microcomputers contained in information processing apparatus. In other words, computers generally refer to apparatus and appliances that can realize the functional features of the present invention by means of a computer program.

The present invention is by no means limited to the above described embodiment, which may be modified in various different ways without departing from the spirit and scope of the invention. Additionally, any of the components of the above described embodiment may be combined differently in various appropriate ways for the purpose of the present invention. For example, some of the components of the above described embodiment may be omitted. Alternatively, components of different embodiments may be combined appropriately in various different ways for the purpose of the present invention.

While certain embodiment of the inventions have been described, these embodiments have been presented by way of example only, and are not intended to limit the scope of the inventions. Indeed, the novel methods and systems described herein may be embodied in a variety on other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An authentication method executed by a host computer comprising at least a first updatable memory device for storing the media key block MKB generated by a key management center unit and a first non-updatable memory device for storing the device key Kd and the center public key Kk-pub generated by the key management center unit on the one hand and by a recording medium comprising a second updatable memory device for storing the media key block MKB and the media key Km generated by the key management center unit and a second non-updatable memory device for storing the center public key Kk-pub, the recording medium certificate Kc-CERT and the recording medium private key Kc-pri generated by the key management center unit on the other hand, the method comprising:
the host computer executing the process of reading the media key block MKB in the second updatable storage device and the recording medium certificate KC-CERT in the second non-updatable storage device from the recording medium;
an MKB verification/updating module of the host computer comparing the version number of the media key block MKB read from the recording medium with the version number of the media key block MKB in the first updatable memory device;
the MKB verification/updating module verifying the key generation center signature of the media key block MKB from the recording medium based on the center public key Kk-pub in the first non-updatable memory device in the case where the comparison result shows that the version number of the media key block MKB from the recording medium is newer;
the MKB verification/updating module rewriting the media key block MKB in the first updatable memory device into the media key block MKB from the recording medium in the case where the verification is successful;
a certificate verification module of the host computer, after the rewrite operation, verifying the key generation center signature of the recording medium certificate Kc-CERT based on the center public key Kk-pub in the first non-updatable memory device;
a recording medium verification module of the host computer reading the media ID from the recording medium certificate Kc-CERT and judging whether the media ID is contained in the recording medium invalidation list of the media key block MKB in the first updatable memory device in the case where the verification is successful;
an MKB processing module of the host computer calculating the media key Km by the MKB process of the media key block MKB from the recording medium based on the device key Kd in the first non-updatable memory device in the case where the judgment shows that the media ID is not contained in the recording medium invalidation list;
a first Kmu generating module of the host computer generating the media unique key Kmu based on the media ID and the media key Km in the recording medium certificate Kc-CERT; and
a first AKE execution module of the host computer executing the authentication and key exchange AKE process with a second AKE execution module of the recording medium based on the media unique key Kmu.

2. The authentication method according to claim 1,
wherein the recording medium further comprises a data verification processing module, a public key decryption processing module and a second Kmu generating module,
the method further comprising:
the recording medium verification module reading the media ID from the recording medium certificate Kc-CERT and judging whether the media ID is contained in the recording medium invalidation list of the media key block MKB in the first updatable memory device in the case where the comparison shows that the version number of the media key block MKB in the host computer is newer;
the MKB processing module calculating the media key Km by the MKB process of the media key block MKB from the recording medium based on the device key Kd in the first non-updatable memory device in the case where the judgment shows that the media ID is not contained in the recording medium invalidation list;
a public key encryption processing module of the host computer encrypting the calculated media key Km with the recording medium public key Kc-pub in the recording medium certificate Kc-CERT and generating the encrypted media key Enc (Kc-pub, Km);
the host computer transmitting the encrypted media key En (Kc-pub, Km) and the media key block MKB in the first updatable memory device to the recording medium;
the data verification processing module, upon receipt of the encrypted media key Enc (Kc-pub, Km) and the media key block MKB by the recording medium, comparing the version number of the media key block MKB from the host computer with the version number of the media key block MKB in the second updatable memory device;
the data verification processing module verifying the key generation center signature in the media key block MKB from the host computer based on the center public key Kk-pub in the second non-updatable memory device in the case where the comparison shows that the version number of the media key block MKB from the host computer is newer;
the public key decryption processing module decrypting the encrypted media key Enc (Kc-pub, Km) from the host computer with the recording medium private key Kc-pri in the second non-updatable memory device in the case where the verification is successful;
the public key decryption processing module verifying the decrypted media key Km with the verification data in the media key block MKB from the host computer;
the data verification processing module rewriting the media key block MKB and the media key Km in the second updatable memory device into the media key block MKB and the media key Km, respectively, received from the host computer in the case where the verification is successful;
the second Kmu generating module generating the medium unique key Kmu based on the rewritten media key Km and the media ID in the recording medium certificate Kc-CERT in the second non-updatable memory device; and
the host computer returning to the process of reading the media key block MKB and the recording medium certificate Kc-CERT from the recording medium after transmission of the encrypted media key Enc (Kc-pub, Km) and the media key block MKB.

3. A host computer communicable with a recording medium having stored therein a media key block MKB, a media key Km, a center public key Kk-pub, a recording medium certificate Kc-CERT and a recording medium private key Kc-pri generated by a key management center unit, comprising:
a first updatable memory device having stored therein the media key block MKB generated by the key management center unit;
a first non-updatable memory device having stored therein the device key Kd and the center public key Kk-pub generated by the key management center unit;
a module configured to execute the process of reading the media key block MKB and the recording medium certificate Kc-CERT from the recording medium;
a module configured to compare the version number of the media key block MKB read from the recording medium with the version number of the media key block MKB in the first updatable memory device;
a module configured to verify the key generation center signature of the media key block MKB from the recording medium based on the center public key Kk-pub in the first non-updatable memory device in the case where the comparison shows that the version number of the media key block MKB from the recording medium is newer;
a module configured to rewrite the media key block MKB in the first updatable memory device to the media key block MKB from the recording medium in the case where the verification is successful;
a module configured to verify the key generation center signature of the recording medium certificate Kc-CERT based on the center public key Kk-pub in the first non-updatable memory device after the rewrite operation;
a module configured to read the media ID from the recording medium certificate Kc-CERT and judge whether the media ID is contained in the recording medium invalidation list of the media key block MKB in the first updatable memory device in the case where the verification is successful;
a module configured to obtain the media key Km by the MKB process of the media key block MKB from the recording medium based on the device key Kd in the first non-updatable memory device in the case where the judgment shows that the media ID is not contained in the recording medium invalidation list;
a module configured to generate the medium unique key Kmu by calculating the one-way function based on the media ID in the recording medium certificate Kc-CERT and the media key Km generated; and
a module configured to execute the authentication and key exchange AKE process with the recording medium based on the medium unique key Kmu.

4. The host computer according to claim 3, further comprising:
a module configured to read the media ID from the recording medium certificate Kc-CERT and judge whether the media ID is contained in the recording medium invalidation list of the media key block MKB in the first updatable memory device in the case where the comparison shows that the version number of the media key block MKB in the first updatable memory device is newer;
a module configured to obtain the media key Km by the MKB process of the media key block MKB from the recording medium based on the device key Kd in the first non-updatable memory device in the case where the judgment shows that the media ID is not contained in the recording medium invalidation list;
a module configured to generate the encrypted media key Enc (Kc-pub, Km) by encrypting the media key Km with the recording medium public key Kc-pub in the recording medium certificate Kc-CERT;
a module configured to transmit the encrypted media key Enc (Kc-pub, Km) and the media key block MKB in the first updatable memory device to the recording medium; and
a module configured to execute the process of reading the media key block MKB and the recording medium certificate Kc-CERT again from the recording medium after transmission of the encrypted media key Enc (Kc-pub, Km) and the media key block MKB.

5. A recording medium communicable with a host computer for storing a media key block MKB, a device key Kd and a center public key Kk-pub generated by a key management center unit, comprising:
a second updatable memory device having stored therein the media key block MKB and the media key Km generated by the key management center unit;
a second non-updatable memory device having stored therein the center public key Kk-pub, the recording medium certificate Kc-CERT and the recording medium private key Kc-pri generated by the key management center unit; and
a module configured in such a manner that after the media key block MKB in the second updatable memory device and the recording medium certificate Kc-CERT in the second non-updatable memory device are read from the host computer, the host computer verifies the key generation center signature of the media key block MKB read from the recording medium based on the center public key Kk-pub in the case where the version number of the media key block MKB read from the recording medium is newer than the version number of the media key block MKB in the host computer, so that in the case where this first verification is successful, the media key block MKB in the host computer is rewritten into the media key block MKB read from the recording medium and then the host computer verifies the key generation center signature of the recording medium certificate Kc-CERT based on the center public key Kk-pub, and in the case where this second verification is successful and the media ID in the recording medium certificate KC-CERT is not contained in the recording medium invalidation list in the updated media key block MKB, then with regard to the medium unique key Kmu with the one-way function calculated by the host computer based on the media key Km obtained by the MKB process of the read media key block MKB based on the device key Kd in the host computer on the one hand and the media ID in the read recording medium certificate KC-CERT on the other hand, the authentication and key exchange AKE is process is executed with the host computer based on the medium unique key Kmu with the one-way function calculated from the media key Km in the second updatable memory device and the media ID in the recording medium certificate Kc-CERT stored in the second non-updatable memory device.

6. The recording medium according to claim 5, further comprising:
a module configured in such a manner that in the case where the version number of the media key block MKB in the host computer is newer than the version number of the media key block MKB read from the recording medium and where the media ID read from the recording medium certificate Kc-CERT by the host computer is not contained in the recording medium invalidation list in the media key block MKB in the host computer, then the encrypted media key Enc (Kc-pub, Km) generated in such a manner that the media key Km, obtained by the MKB process of media key block MKB from the recording medium based on the device key Kd in the host computer, is encrypted with the recording medium public key Kc-pub in the recording medium certificate Kc-CERT on the one hand and the media key block MKB in the host computer on the other hand are received from the host computer;
a module configured to compare the version number of the media key block MKB read from the host computer with the version number of the media key block MKB in the second updatable memory device;
a module configured to verify the key generation center signature in the media key block MKB read from the host computer based on the center public key Kk-pub in the second non-updatable memory device in the case where the comparison shows that the version number of the media key block MKB read from the host computer is newer;
a module configured to decrypt the encrypted media key from the host computer with the recording medium private key Kc-pri in the second non-updatable memory device in the case where the verification is successful;
a module configured to verify the decrypted media key Km with the verification data in the media key block MKB read from the host computer;
a module configured to rewrite the media key block MKB and the media key Km in the second updatable memory device to the media key block MKB and the media key Km, respectively, received from the host computer in the case where the verification is successful;
a module configured to generate the medium unique key Kmu based on the rewritten media key Km and the media ID in the recording medium certificate Kc-CERT in the second non-updatable memory device; and
a module configured to execute the authentication and key exchange AKE process with the host computer based on the media unique key Kmu.

7. An authentication method executed by a host computer comprising at least a first updatable memory device for storing the media key block MKB generated by a key management center unit and a first non-updatable memory device for storing the device key Kd_h generated by the key management center unit on the one hand and by a recording medium comprising a second updatable memory device for storing the media key block MKB and the media key Km generated by the key management center unit and a second non-updatable memory device for storing the device key Kd_c and the media ID generated by the key management center unit on the other hand, the method comprising:
the host computer executing the process of reading the media key block MKB in the second updatable memory device and the media ID in the second non-updatable memory device from the recording medium;
an MKB processing module of the host computer executing the MKB process of the media key block MKB read from the recording medium based on the device key Kd_h in the first non-updatable memory device;
an MKB comparison module of the host computer comparing the version number of the media key block MKB read from the recording medium with the version number of the media key block MKB in the first updatable memory device;
the MKB comparison module rewriting the media key block MKB in the first updatable memory device into the media key block MKB read from the recording medium in the case where the comparison shows that the version number of the media key block MKB read from the recording medium is newer;
a first Km generating module of the host computer generating, after the rewrite operation, the medium unique key Kmu based on the media ID read from the recording medium and the media key Km obtained by the MKB process; and
a first AKE execution module of the host computer executing the authentication and key exchange AKE process with a second AKE execution module of the recording medium based on the medium unique key Kmu.

8. The authentication method according to claim 7,
wherein the recording medium further comprises an MKB processing module, an MKB comparison module and a second Kmu generating module;
the method further comprising:
the host computer transmitting the media key block MKB in the first updatable memory device to the recording medium in the case where the comparison shows that the version number of the media key block MKB in the host computer is newer;
the MKB processing module, upon receipt of the particular media key block MKB by the recording medium, executing the MKB process of the media key block MKB read from the host computer based on the device key Kd_c in the second non-updatable memory device and sending out the media key block MKB from the recording medium to the MKB comparison module;
the MKB comparison module comparing the version number of the media key block MKB read from the host computer with the version number of the media key block MKB in the second updatable memory device;
the MKB processing module verifying the media key Km obtained from the media key block MKB read from the host computer, using the verification data in the media key block MKB read from the host computer in the case where the comparison shows that the version number of the media key block MKB from the host computer is newer;
the MKB processing module rewriting the media key block MKB and media key Km in the second updatable memory device into the media key block MKB and the media key Km, respectively, received from the host computer in the case where the verification is successful;
the second Kmu generating module generating the medium unique key Kmu based on the rewritten media key Km and the media ID in the second non-updatable memory device; and
the host computer returning to the process of reading the media key block MKB and the media ID from the recording medium after transmission of the media key block MKB.

9. A host computer communicable with a recording medium having stored therein a media key block MKB, a media key Km, a device key Kd-c and a media ID generated by a key management center unit, comprising:
a first updatable memory device having stored therein the media key block MKB generated by the key management center unit;
a first non-updatable memory device having stored therein the device key Kd_h generated by the key management center unit;
a module configured to read the media key block MKB and the media ID from the recording medium;
a module configured to execute the MKB process of the media key block MKB read from the recording medium based on the device key Kd_h in the first non-updatable memory device;
a module configured to compare the version number of the media key block MKB read from the recording medium with the version number of the media key block MKB in the first updatable memory device;
a module configured to rewrite the media key block MKB in the first updatable memory device into the media key block MKB read from the recording medium, in the case where the comparison shows that the version number of the media key block MKB read from the recording medium is newer;
a module configured to generate the medium unique key Kmu based on the media ID read from the recording medium and the media key Km obtained by the MKB process after the rewrite operation; and
a module configured to execute the authentication and key exchange AKE process with the recording medium based on the medium unique key Kmu.

10. The host computer according to claim 9, further comprising:
a module configured to transmit the media key block MKB in the first updatable memory device to the recording medium in the case where the comparison shows that the version number of the media key block MKB in the first updatable memory device is newer; and
a module configured to execute the process of reading the media key block MKB and the media ID again from the recording medium after transmission of the media key block MKB.

11. A recording medium communicable with a host computer having stored therein the media key block MKB and the device key Kd_h generated by a key management center unit, comprising:
a second updatable memory device having stored therein the media key block MKB and the media key Km generated by the key management center unit;
a second non-updatable memory device having stored therein the device key Kd_c and the media ID generated by the key management center unit; and
a module configured in such a manner that after the media key block MKB in the second updatable memory device and the media ID in the second non-updatable memory device are read from the host computer, the host computer executes the MKB process of the media key block MKB read from the recording medium based on the device key Kd_h and compares the version number of the media key block MKB read from the recording medium with the version number of the media key block MKB in the host computer,
wherein in the case where the version number of the media key block MKB read from the recording medium is newer than the version number of the media key block MKB in the host computer, the host computer rewrites the media key block MKB in the host computer into the medium key block MKB read from the recording medium, and
after the rewrite operation, with regard to the medium unique key Kmu generated based on the media key Km obtained by the MKB process and the media ID read from the recording medium, the authentication and key exchange AKE process is executed with the host computer based on the medium unique key Kmu generated based on the media key Km in the second updatable memory device and the media ID stored in the second non-updatable memory device.

12. The recording medium according to claim 11, further comprising:
a module configured to receive the media key block MKB in the host computer from the host computer in the case where the version number of the media key block MKB in the host computer is newer than the version number of the media key block MKB read from the recording medium;
a module configured to compare the version number of the media key block MKB read from the host computer with the version number of the media key block MKB in the second updatable memory device;
a module configured to verify the media key Km obtained by the media key block MKB from the host computer with the verification data in the media key block MKB read from the host computer in the case where the comparison shows that the version number of the media key block MKB read from the host computer is newer;
a module configured to rewrite the media key block MKB and the media key Km in the second updatable memory device into the media key block MKB and the media key Km, respectively, received from the host computer in the case where the verification is successful;
a module configured to generate the medium unique key Kmu based on the rewritten media key Km and the media ID in the second non-updatable memory device; and
a module configured to execute the authentication and key exchange AKE process with the host computer based on the medium unique key Kmu.
